(19) United States
(12) Patent Application Publication
(10) Pub. No.: US 2026/0340908 A1
(43) Pub. Date: Oct. 29, 2026

(54) VIDEO GENERATION METHOD, DEVICE, AND STORAGE MEDIUM

(71) Applicant: Beijing Zitiao Network Technology Co., Ltd., Beijing (CN)

(72) Inventors: Zaiyu HUANG, Beijing (CN); Xin DONG, Beijing (CN); Tongchun ZUO, Beijing (CN)

(21) Appl. No.: 19/657,922

(22) Filed: Apr. 24, 2026

(30) Foreign Application Priority Data
Apr. 25, 2025 (CN) 202510534204.1

(51) Int. Cl. G06T 11/60; G06V 10/774; G06V 20/40

(52) U.S. Cl. CPC G06T 11/60; G06V 10/774; G06V 20/40

(57) ABSTRACT

A video generation method includes: obtaining a reference image, a first video, and at least one skeleton image, where different skeleton images indicate different information; generating at least one image based on the reference image and the at least one skeleton image, so that the at least one image may indicate a state of an object in the reference image under the information indicated by each of the at least one skeleton image, thereby enabling the at least one image to better present characteristics of the object; and generating a second video based on the at least one image and the first video, so that the second video may indicate states of the object in the reference image under an action sequence indicated by the first video, thereby driving the object in the reference image to act according to the action sequence indicated by the video.

### CROSS-REFERENCE TO RELATED APPLICATIONS

The present application is based on and claims priority to Chinese Patent Application No. 202510534204.1, and filed on Apr. 25, 2025, the entire disclosure of the Chinese Patent Application is hereby incorporated by reference in its entirety.

### TECHNICAL FIELD

The present disclosure relates to the field of data processing technology and, in particular, to a video generation method, a device, and a medium.

### BACKGROUND

For some scenarios, such as a video try-on scenario, a film and television effect scenario, and the like, these scenarios may have a requirement as follows: given a reference image and a video, driving an object in the reference image to act according to an action sequence indicated by a video.

### SUMMARY

To meet the above requirement, the present disclosure provides a video generation method, a device, a medium, and a product.

To achieve the above objective, the technical solutions provided in the present disclosure are as follows:

The present disclosure provides a video generation method. The method includes: acquiring a reference image, a first video, and at least one skeleton image, wherein different skeleton images indicate different information, and the information includes at least one of an action or a view; generating at least one image based on the reference image and the at least one skeleton image, wherein the at least one image indicates a state of an object in the reference image under the information indicated by each of the at least one skeleton image; and generating a second video based on the at least one image and the first video, wherein the second video indicates states of the object in the reference image under an action sequence indicated by the first video.

In a possible implementation, the generating at least one image based on the reference image and the at least one skeleton image includes: in response to detecting that the reference image does not satisfy a constraint, generating the at least one image based on the reference image and the at least one skeleton image, wherein each of the at least one image satisfies the constraint, the constraint indicates a requirement for at least one of a body posture or body integrity of an object in an image used in a video generation process, and the used image indicates an appearance of the object in a video obtained through the video generation process.

In a possible implementation, the at least one image is generated using a first model, the first model includes a main network and a reference network, input data of the reference network includes an encoding result of the reference image, and the main network processes an encoding result of the at least one skeleton image based on output data of the reference network; for any self-attention module in the main network, the main network includes a first network layer corresponding to the self-attention module, the first network layer generates a discretization feature corresponding to each of the at least one skeleton image, the reference network includes a second network layer corresponding to the self-attention module, and the second network layer generates a discretization feature corresponding to the reference image; and for any skeleton image of the at least one skeleton image, the self-attention module performs self-attention processing on a concatenation result of the discretization feature corresponding to the skeleton image, discretization features corresponding to skeleton images other than the skeleton image in the at least one skeleton image, and the discretization feature corresponding to the reference image, to obtain a processed feature corresponding to the skeleton image.

In a possible implementation, the at least one image is generated using a first model; and a training process of the first model includes: acquiring at least one label image, a skeleton image of each of the at least one label image, and a reference image corresponding to the at least one label image, wherein an object in the reference image corresponding to the at least one label image and an object in each of the at least one label image are the same; inputting the skeleton image of the at least one label image and the reference image corresponding to the at least one label image into the first model, to obtain a predicted image corresponding to each of the at least one label image that is output by the first model; and updating the first model based on a difference between the predicted image corresponding to the at least one label image and the at least one label image.

In a possible implementation, the training process is performed with a first probability, and the first model learns to perform image generation processing under a control condition through the training process.

In a possible implementation, the training process is performed with a second probability, and the first model learns to generate a same image under a control condition through the training process; and each of the at least one label image is the same image, and a difference between a state of the object in the same image and a state of the object in the reference image corresponding to the at least one label image meets a condition.

In a possible implementation, the object in the reference image corresponding to the at least one label image is from a front view, and the object in the same image is from a back view.

In a possible implementation, the training process is performed with a third probability, and the first model learns to perform image generation processing without a control condition through the training process; the acquiring at least one label image, a skeleton image of each of the at least one label image, and a reference image corresponding to the at least one label image includes: acquiring the at least one label image and the skeleton image of each of the at least one label image, wherein objects in different label images are different; and the inputting the skeleton image of the at least one label image and the reference image corresponding to the at least one label image into the first model includes: inputting the skeleton image of the at least one label image into the first model, wherein input data of a reference network in the first model is 0.

In a possible implementation, the training process is performed with a fourth probability, and the first model learns to generate images describing different objects under different control conditions through the training process; and the acquiring at least one label image, a skeleton image of each of the at least one label image, and a reference image corresponding to the at least one label image includes: acquiring the at least one label image, the skeleton image of each of the at least one label image, and a reference image matched with each of the at least one label image, wherein objects in different label images are different, and for any label image, an object in the label image and an object in the reference image matched with the label image are the same; and the inputting the skeleton image of the at least one label image and the reference image corresponding to the at least one label image into the first model includes: inputting the skeleton image of the at least one label image and the reference image matched with the at least one label image into the first model.

In a possible implementation, input data of a reference network in the first model includes an encoding result of the reference image matched with the at least one label image, and the main network in the first model processes an encoding result of the skeleton image of the at least one label image based on output data of the reference network; for any self-attention module in the main network, the main network includes a first network layer corresponding to the self-attention module, the first network layer generates a discretization feature corresponding to the skeleton image of each of the at least one label image, the reference network includes a second network layer corresponding to the self-attention module, and the second network layer generates a discretization feature corresponding to the reference image matched with each of the at least one label image; and for any label image of the at least one label image, the self-attention module performs self-attention processing on a concatenation result of the discretization feature corresponding to the skeleton image of the label image, discretization features corresponding to skeleton images of label images other than the label image in the at least one label image, and the discretization feature corresponding to the reference image matched with the label image, to obtain a processed feature corresponding to the skeleton image of the label image.

In a possible implementation, the training process further includes: acquiring a first text corresponding to the at least one label image and a second text corresponding to the at least one label image, wherein the first text and the second text describe the at least one label image; and wherein, input data of the first model further includes the first text and the second text, input data of the reference network in the first model includes at least an encoding result of the second text, and input data of the main network in the first model includes at least an encoding result of the first text.

In a possible implementation, the training process further includes: adding a module to each self-attention module in the first model; and the updating the first model based on a difference between the predicted image corresponding to the at least one label image and the at least one label image includes: updating each added module in the first model based on the difference between the predicted image corresponding to the at least one label image and the at least one label image.

In a possible implementation, the second video is generated further based on an empty background image of each of the at least one image; and for any one of the at least one image, an acquisition process of the empty background image of the image includes: identifying a foreground region from the image, wherein the foreground region indicates a location of an object in the image; cutting out the foreground region from the image; and performing image inpainting on the image to obtain the empty background image of the image.

In a possible implementation, the second video is generated using a second model, and the second model is trained based on a sample video, a reference image corresponding to the sample video, and an empty background image of a reference image corresponding to the sample video; and an acquisition process of the sample video, the reference image corresponding to the sample video, and the empty background image of the reference image corresponding to the sample video, includes: extracting a video clip from a third video to obtain the sample video, extracting a first image from the third video to obtain the reference image corresponding to the sample video, and using an empty background image of the first image as the empty background image of the reference image corresponding to the sample video.

In a possible implementation, an acquisition process of the sample video, the reference image corresponding to the sample video, and the empty background image of the reference image corresponding to the sample video, includes: extracting the video clip and the first image from the third video, and extracting a second image from a fourth video, wherein there is a difference between an empty background image of the second image and the empty background image of the first image; and performing background replacement on each image in the video clip based on the empty background image of the second image to obtain the sample video, performing background replacement on the first image based on the empty background image of the second image to obtain the reference image corresponding to the sample video, and using the empty background image of the second image as the empty background image of the reference image corresponding to the sample video.

In a possible implementation, the second video is generated using a second model, and the second model is trained based on a sample video; and an acquisition process of the sample video includes: extracting a video clip from a third video, wherein an object in a first frame image of the video clip is from a front view, and an object in a last frame image of the video clip is from a back view; and determining the sample video based on the video clip.

In a possible implementation, the at least one skeleton image includes a skeleton image of an image selected from the first video.

In a possible implementation, the second video is generated based on a skeleton image of each image in the first video.

The present disclosure provides an electronic device. The device includes: a processor and a memory, where the memory is configured to store instructions or a computer program, and the processor is configured to execute the instructions or the computer program in the memory, to enable the electronic device to perform the video generation method provided in the present disclosure.

The present disclosure provides a computer-readable medium having instructions or a computer program stored thereon, where the instructions or the computer program, when executed by a device, enables the device to perform the video generation method provided in the present disclosure.

### BRIEF DESCRIPTION OF THE DRAWINGS

To describe the technical solutions in the embodiments of the present disclosure or in the related art more clearly, the following briefly describes the drawings used in describing the embodiments or the related art. Apparently, the drawings in the following description show merely some embodiments of the present disclosure, and a person of ordinary skill in the art may still derive other drawings from these drawings without creative efforts.

FIG. 1 is a schematic diagram of a video generation method according to an embodiment of the present disclosure.

FIG. 2 is a schematic diagram of driving a video based on a reference image according to an embodiment of the present disclosure.

FIG. 3 is a schematic diagram of an optimization process of a reference image according to an embodiment of the present disclosure.

FIG. 4 is a schematic diagram of an information sharing manner under a single control condition according to an embodiment of the present disclosure.

FIG. 5 is a schematic diagram of an information sharing manner under a plurality of control conditions according to an embodiment of the present disclosure.

FIG. 6 is a schematic diagram of another optimization process of a reference image according to an embodiment of the present disclosure.

FIG. 7 is a schematic diagram of a video driving process according to an embodiment of the present disclosure.

FIG. 8 is a schematic diagram of an acquisition process of an empty background image according to an embodiment of the present disclosure.

FIG. 9 is a schematic structural diagram of a video generation apparatus according to an embodiment of the present disclosure.

FIG. 10 is a schematic structural diagram of an electronic device according to an embodiment of the present disclosure.

### DETAILED DESCRIPTION OF EMBODIMENTS

Research has found that in some scenarios, such as a scenario of changing clothes or a film and television effect, a diffusion model may be used to implement the foregoing processing requirement (also referred to as a video driving requirement) of "given a reference image and a video, driving an object in the reference image to act according to an action sequence indicated by a video".

Research has further found that for the solution shown in the preceding paragraph, the solution has a very strict restriction on the reference image, such as a restriction that a posture of the object in the reference image is simple and a body of the object in the reference image is complete. However, in an actual use process of the solution, because the reference image given by the user is obtained by shooting a real scene in real life, the reference image may have problems such as a complex posture and an incomplete body (also referred to as an incomplete frame), so that the reference image cannot satisfy the above strict restriction, which in turn leads to a poor quality of a video finally generated by using the solution, and thus the robustness of the solution is relatively poor.

Based on the preceding research, to overcome the preceding defect, the present disclosure provides a video generation method. The method includes: first obtaining a reference image (such as an image that is given by a user and that does not satisfy the above strict restriction), a first video (a video that is given by a user and that indicates an action sequence), and at least one skeleton image (such as a skeleton image that describes a certain action), where different skeleton images indicate different information (such as an action and/or a view); then generating at least one image (such as some images that may present simple actions and are complete in frame) based on the reference image and the at least one skeleton image, so that the at least one image may indicate a state of the object in the reference image under the information indicated by each of the at least one skeleton image, thereby enabling the at least one image to better present characteristics of the object; and then generating a second video based on the at least one image and the first video, so that the second video may indicate states of the object in the reference image under the action sequence indicated by the first video, thereby driving the object in the reference image to act according to the action sequence indicated by the video. Among them, because the at least one skeleton image may indicate some simple actions, the at least one image generated based on the at least one skeleton image and the reference image may better satisfy the preceding strict restriction, so that the at least one image may more accurately and comprehensively describe the characteristics of the object in the reference image, so that the video generated based on the at least one image may better maintain the characteristics of the object, which is favorable for improving a video generation effect.

In addition, an execution body of the video generation method is not limited in the present disclosure, for example, the method may be applied to a terminal device or a server. For another example, the method may alternatively be implemented by using a data interaction process between a terminal device and a server. The terminal device may be a smartphone, a computer, a personal digital assistant (PDA), a tablet computer, or the like. The server may be a stand-alone server, a cluster server, or a cloud server.

To help persons skilled in the art better understand the solutions of the present disclosure, the technical solutions in the embodiments of the present disclosure are described below clearly and completely with reference to the drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

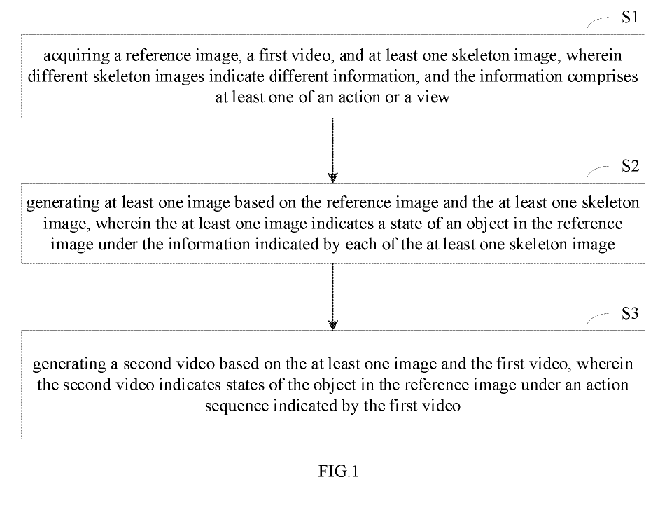

To better understand the technical solutions provided in the present disclosure, the video generation method provided in the present disclosure will be first described below with reference to some drawings. As shown in FIG. 1, a video generation method according to an embodiment of the present disclosure includes the following steps S1 to S3.

Step S1: acquiring a reference image, a first video, and at least one skeleton image, where different skeleton images indicate different information, and the information includes an action and/or a view.

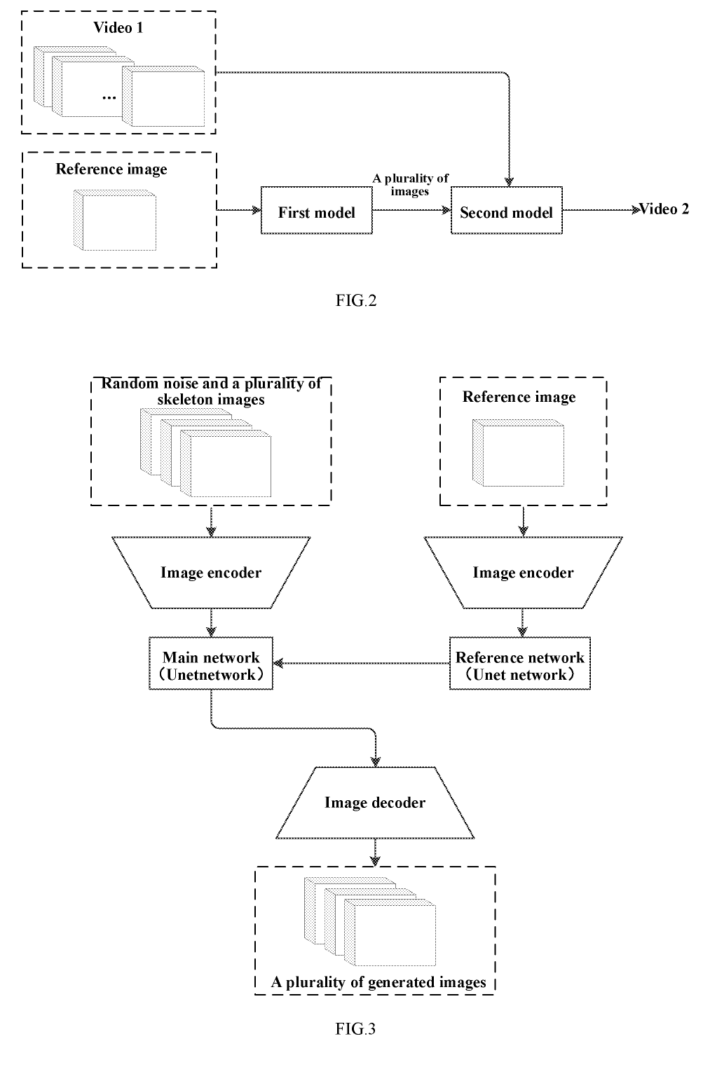

The reference image refers to an image that is given by a user and that may indicate an appearance of an object (the reference image shown in FIG. 2), so that the reference image may describe an appearance, such as a face, clothes, and a figure, of the object in each image in a finally generated video (video 2 shown in FIG. 2). It should be noted that an implementation of the object is not limited in the present disclosure. For example, the object may be implemented by a real person, a virtual character, an animal, or the like.

In addition, an acquisition manner of the reference image is not limited in the present disclosure. For example, the reference image may be provided or selected by the user through some input devices. For another example, the reference image may be provided by another task in a device that performs the video generation method.

The first video refers to a video that is given by a user and that may indicate an action sequence (video 1 shown in FIG. 2), so that the first video may describe an action of the object in each image in a finally generated video (video 2 shown in FIG. 2).

In addition, an acquisition manner of the first video is not limited in the present disclosure. For example, the first video may be provided or selected by the user through some input devices. For another example, the first video may be provided by another task in a device that performs the video generation method.

The at least one skeleton image refers to a skeleton image (a plurality of skeleton images shown in FIG. 3) required when the reference image is optimized, and different skeleton images in the at least one skeleton image indicate different information (such as an action and/or a view), so that the at least one skeleton image may more clearly, accurately, and comprehensively describe characteristics of the object in the reference image, such as an appearance and a body state in different postures. It should be noted that an implementation of the information is not limited in the present disclosure. For example, the information may include an action and/or a view. The action may indicate a body posture of the object in an image. The view may indicate a shooting angle of the object in an image.

In addition, in some scenarios, the at least one skeleton image may satisfy at least the following constraints: the action indicated by each of the at least one skeleton image is a simple action, and a body indicated by each of the at least one skeleton image is complete, so that the object in an image obtained by optimizing the reference image (the reference image shown in FIG. 3) based on the at least one skeleton image may present not only the simple action, but also the complete body, which may better satisfy the preceding strict restriction.

In addition, an acquisition manner of the at least one skeleton image is not limited in the present disclosure. For example, the at least one skeleton image may be some skeleton images specified by a related person for a current application scenario, so that the actions indicated by these skeleton images may satisfy a control condition constraint for a video generation process in the application scenario. The control condition constraint may indicate a restriction that needs to be met by an image that is used in the video generation process and that may describe the appearance of the object in the finally generated video, such as a restriction that the action of the object in the image belongs to the simple actions and a restriction that the body of the object in the image is complete.

Step S2: generating at least one image based on the reference image and the at least one skeleton image, where the at least one image indicates a state of an object in the reference image under information indicated by each of the at least one skeleton image.

The at least one image is obtained by optimizing the reference image based on the at least one skeleton image, so that the at least one image (a plurality of images shown in FIGS. 2 or 3) may indicate the state of the object in the reference image under the information (such as the action and/or the view) indicated by each of the at least one skeleton image, thereby enabling the at least one image to better satisfy the preceding strict restriction than the reference image.

In addition, a number of images in the at least one image may be the same as a number of images in the at least one skeleton image, so that an object state (such as an action and/or a view) presented by each of the at least one image is consistent with the information (such as the action and/or the view) indicated by each of the at least one skeleton image.

It may be learned that in a possible implementation, if the at least one skeleton image includes N skeleton images, the at least one image may include N images, so that a state (such as an action and a view) of the object in a first image is consistent with information indicated by a first skeleton image, a state (such as an action and a view) of the object in a second image is consistent with information indicated by a second skeleton image, ... , and so on, and a state (such as an action and a view) of the object in an Nth image is consistent with information indicated by an Nth skeleton image, where N is a positive integer.

In addition, an implementation of step S2 is not limited in the present disclosure. For example, step S2 may be implemented by using any pre-built machine learning model that may generate some new images based on some skeleton images and a reference image, for example, any diffusion model or the dual UNet-based machine learning model shown in FIG. 3. The UNet network is a symmetric network that presents a U-shaped structure. Downsampling is implemented on a left side of the UNet network, and upsampling is implemented on a right side of the UNet network.

It should be noted that for the dual UNet-based machine learning model shown in FIG. 3, an image encoder in the model may perform encoding processing on an image to obtain an encoding result of the image. An implementation of the image encoder is not limited in the present disclosure. For example, the image encoder may be implemented by using any encoder that may perform encoding processing on an image, for example, an encoding module in a variational Auto-Encoder (VAE). In addition, a reference network in the model may extract some features from an image (the reference image shown in FIG. 3) and provide the features to a main network in the model for use; and the reference network may be implemented by using a UNet network. In addition, the main network in the model may process some data (random noise and a plurality of skeleton images shown in FIG. 3) based on the features provided by the reference network. The main network is also implemented by using a UNet network. A network structure of the main network is the same as a network structure of the reference network, but parameters in the main network are different from parameters in the reference network, so that a function (such as an image generation function) implemented by the main network is different from a function (such as a feature extraction function) implemented by the reference network. In addition, an image decoder in the model may perform decoding processing on output data of the main network to obtain some new images (a plurality of images shown in FIG. 3). An implementation of the image decoder is not limited in the present disclosure. For example, the image decoder may be implemented by using any decoder that may perform decoding processing on an image feature, for example, a decoding module in a VAE.

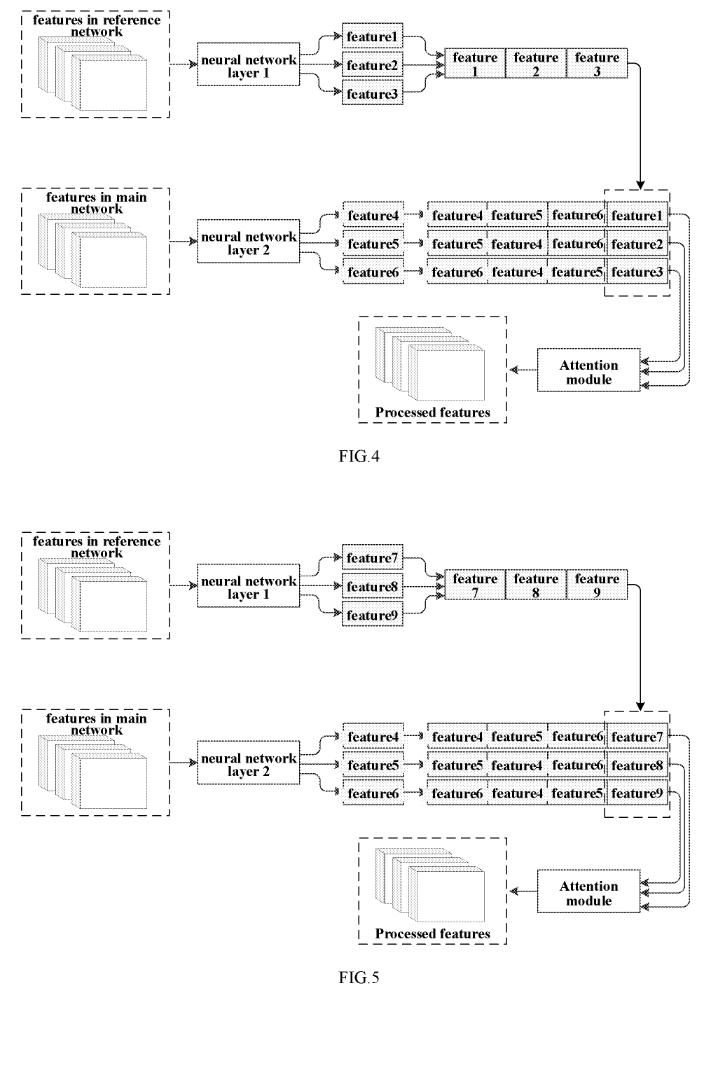

It should be further noted that for the dual UNet-based machine learning model shown in FIG. 3, how the main network in the model uses output data of the reference network in the model is not limited in the present disclosure. For example, for any self-attention module (the attention module shown in FIG. 4) in the main network, input data of the self-attention module is obtained by concatenating output data of a previous network layer (neural network layer 2 shown in FIG. 4) corresponding to the self-attention module in the main network and output data of a network layer (neural network layer 1 shown in FIG. 4) in the reference network that is at a same position as the previous network layer.

It should be still further noted that the two image encoders shown in FIG. 3 may be implemented by using a same encoder, or may be implemented by using different encoders, which is not specifically limited in the present disclosure.

It should be further noted that for the random noise shown in FIG. 3, because the dual UNet-based machine learning model shown in FIG. 3 is a diffusion model, the random noise in the input data of the model refers to randomly generated noise data, and a number of the random noises in the input data of the model is the same as a number of images in the plurality of skeleton images shown in FIG. 3.

It may be learned based on the related content of the dual UNet-based machine learning model shown in FIG. 3 that in a possible implementation, when the at least one skeleton image includes N skeleton images, step S2 may specifically include: inputting the reference image, an ith skeleton image, and randomly generated noise data (the random noise shown in FIG. 3) into the model, so that the model may process the noise data based on the reference image and the ith skeleton image to generate an ith image, where the ith image may indicate a state of the object in the reference image under information (such as an action and a view) indicated by the ith skeleton image, thereby enabling a body state (such as a posture of each body part and a body orientation) of the object in the ith image to be consistent with a body state indicated by the ith skeleton image, and enabling content (such as an appearance of the object and a background) other than the body state in the ith image to be consistent with corresponding content in the reference image, where i is a positive integer, and i≤N.

Step S3: generating a second video based on the at least one image and the first video, where the second video indicates states of the object in the reference image under an action sequence indicated by the first video.

The second video is a result (video 2 shown in FIG. 2) obtained by driving the first video based on the at least one image as discussed above, so that an appearance of the object in the second video is consistent with an appearance of the object in the at least one image (a plurality of images shown in FIG. 2), and an action sequence indicated by the second video is consistent with the action sequence indicated by the first video, thereby enabling the second video to indicate states of the object in the at least one image under the action sequence indicated by the first video, and enabling the second video to indicate states of the object in the reference image (the reference image shown in FIG. 2) under the action sequence indicated by the first video, so that the second video may represent a result of driving the object in the reference image to perform corresponding actions in the first video.

In addition, an implementation of a background in the second video is not limited in the present disclosure. For example, in some scenarios, such as a scenario of keeping a background of an original video during video driving, the background in the second video may be obtained by keeping a background in the first video. For another example, in some scenarios, such as a scenario of keeping only an action sequence in an original video without keeping other content during video driving, the background in the second video may be obtained by keeping a background in the at least one image.

In addition, an implementation of step S3 is not limited in the present disclosure. For example, step S3 may be implemented by using any pre-built machine learning model that may drive the first video based on some images, for example, a Transformer-based diffusion model (Diffusion Transformer, DIT). The DIT is a diffusion model with Transformer as its main component, and the DIT is obtained by using Transformer to replace UNet network in a traditional diffusion model.

It may be learned based on the related content of above steps S1 to S3 that in the video driving solution (the video driving solution shown in FIG. 2) provided in the present disclosure, a reference image (such as an image that is given by a user and that does not satisfy the above strict restriction), a first video (a video that is given by a user and that indicates an action sequence), and at least one skeleton image (such as a skeleton image that describes a certain action) are first obtained, where different skeleton images indicate different information (such as an action and/or a view); then at least one image (such as some images that may present simple actions and are complete in frame) is generated based on the reference image and the at least one skeleton image, so that the at least one image may indicate a state of the object in the reference image under the information indicated by each of the at least one skeleton image, thereby enabling the at least one image to better present characteristics of the object; and then a second video is generated based on the at least one image and the first video, so that the second video may indicate states of the object in the reference image under the action sequence indicated by the first video, thereby driving the object in the reference image to act according to the action sequence indicated by the video. Among them, because the at least one skeleton image may indicate some simple actions, the at least one image generated based on the at least one skeleton image and the reference image may better satisfy the preceding strict restriction, so that the at least one image may more accurately and comprehensively describe the characteristics of the object in the reference image, so that the video generated based on the at least one image may better maintain the characteristics of the object, which is favorable for improving a video generation effect.

In addition, in some scenarios, to better improve flexibility, the present disclosure further provides an implementation of the at least one skeleton image. In this implementation, the at least one skeleton image includes a skeleton image of an image selected from the first video, so that the at least one skeleton image may describe some simple actions in the first video, which not only improves acquisition flexibility of the at least one skeleton image, but also is favorable for improving a video generation effect.

It may be learned that in a possible implementation, after the first video (video 1 shown in FIG. 2) given by the user is obtained, an action complexity of each image in the first video can be first analyzed; then some images are selected from the first video based on the action complexities, so that the action complexities of the images are not greater than that of other images other than the images in the video; and then based on skeleton images of such images, the above at least one skeleton image is determined, so that the at least one skeleton image includes the skeleton images of such images, thereby enabling the at least one skeleton image to represent some simple actions that appear in the first video.

It should be noted that for any image in the first video, the action complexity of the image may indicate a complexity degree of an action of the object in the image, so that the action complexity may represent whether the action of the object in the image belongs to a simple action. In addition, an acquisition manner of the action complexity of the image is not limited in the present disclosure. For example, the action complexity may be acquired by using a pre-built machine learning model having a function of evaluating an action complexity of an image. For another example, the action complexity of the image may be obtained by performing action analysis on a skeleton image of the image. The skeleton image of the image may indicate a body posture of the object in the image.

In addition, in some scenarios, such as a scenario that focuses on action keeping during video driving, to better improve a video generation effect, the present disclosure further provides a possible implementation of the second video. In this implementation, the second video may be generated based on a skeleton image of each image in the first video, so that the action sequence indicated by the second video is consistent with an action sequence indicated by the skeleton image of each image in the first video. The skeleton image of each image in the first video may more accurately describe the action sequence indicated by the first video, so that the second video generated based on the skeleton image may better keep the action sequence, which is favorable for better improving the video generation effect.

It may be learned that in a possible implementation, after the first video (video 1 shown in FIG. 2) given by the user is obtained, a skeleton image of each image in the first video is first obtained, so that the action sequence indicated by the first video may be more accurately described by the skeleton images; and then the second video is generated based on the skeleton image of each image in the first video and the above at least one image (a plurality of images shown in FIG. 2) obtained by optimizing the reference image given by the user, so that the second video may better represent the state of the object in the reference image under the action sequence indicated by the first video, which is favorable for better improving an action keeping effect during video generation, thereby facilitating an improvement in the video generation effect.

Research has found that the reference image given by the user may or may not satisfy the restriction that "a posture of an object in an image is simple and a body of the object in the image is complete".

It may be learned based on the preceding research that to better improve efficiency, the present disclosure further provides a possible implementation of step S2. In this implementation, step S2 may specifically include: in response to detecting that the reference image does not satisfy a constraint (for example, the preceding restriction that "the posture of the object in the image is simple and the body of the object in the image is complete"), generating the at least one image based on the reference image and the at least one skeleton image, where each of the at least one image satisfies the constraint, the constraint indicates a requirement for a body posture and/or body integrity of an object in an image (for example, an image that exists as a control condition during video driving and that may indicate an appearance of the object in a finally generated video) used in a video generation process, for example, requirements that an action is simple, a body is complete, or the like, and the used image indicates the appearance of the object in the video obtained through the video generation process. In this manner, it may be ensured that only the reference image that does not satisfy the restriction is optimized, which is favorable for better improving efficiency.

It may be learned that after the reference image (the reference image shown in FIG. 2) given by the user is acquired, it is first judged whether the reference image satisfies a constraint (also referred to as a preset constraint). If the reference image satisfies the constraint, it may be determined that the reference image satisfies the restriction that "the posture of the object in the image is simple and the body of the object in the image is complete", and therefore the first video may be directly driven by using the reference image as a control condition, to obtain the second video. However, if the reference image does not satisfy the constraint, it may be determined that the reference image does not satisfy the restriction that "the posture of the object in the image is simple and the body of the object in the image is complete", and therefore the at least one image may be generated based on the reference image and the at least one skeleton image, so that each of the at least one image satisfies the constraint, thereby enabling each of the at least one image to satisfy the restriction that "the posture of the object in the image is simple and the body of the object in the image is complete", and enabling the video generation process implemented based on the at least one image to present strong robustness, which is favorable for improving a video generation effect.

Research has found that for some scenarios, such as a scenario in which a background in the reference image does not need to be kept during video driving, restrictions specified for the reference image in these scenarios include: a restriction that a posture of an object in the image is simple, a restriction that a body of the object in the image is complete, a restriction that a background in the image is simple, and the like.

It may be learned based on the preceding research that to better improve a video generation effect, the present disclosure further provides a possible implementation of the at least one image (the plurality of images shown in FIGS. 2 or 3). In this implementation, the at least one image may be generated further based on a preset background image. A background indicated by the preset background image belongs to a simple background specified by such restrictions that "the posture of the object in the image is simple, the body of the object in the image is complete, the background in the image is simple", so that the at least one image generated based on the preset background image may better satisfy such restrictions, thereby enabling the video generation process implemented based on the at least one image to present strong robustness, which is favorable for improving the video generation effect.

It may be learned that after the reference image (the reference image shown in FIG. 2) given by the user is acquired, if it is determined that the reference image does not satisfy a background constraint and does not satisfy a foreground constraint (such as the preceding preset constraint), it may be determined that the reference image does not satisfy such restriction that "the posture of the object in the image is simple, the body of the object in the image is complete, the background in the image is simple", and therefore the at least one image may be generated based on the reference image, the at least one skeleton image, and the preset background image, so that each of the at least one image simultaneously satisfies the foreground constraint and the background constraint;

if it is determined that the reference image satisfies the background constraint but does not satisfy the foreground constraint, it may be determined that the reference image just does not satisfy the restriction that "the posture of the object in the image is simple and the body of the object in the image is complete", and therefore the at least one image may be generated based on the reference image and the at least one skeleton image, so that each of the at least one image simultaneously satisfies the foreground constraint and the background constraint;

if it is determined that the reference image satisfies the foreground constraint but does not satisfy the background constraint, it may be determined that the reference image just does not satisfy the restriction that "the background in the image is simple", and therefore the at least one image may be generated based on the reference image and the preset background image, so that each of the at least one image simultaneously satisfies the foreground constraint and the background constraint; and

if it is determined that the reference image satisfies both the background constraint and the foreground constraint, it may be determined that the reference image satisfies the restrictions that "the posture of the object in the image is simple, the body of the object in the image is complete, and the background in the image is simple", and therefore the first video may be directly driven by using the reference image as a control condition, to obtain the second video.

Research has found that for the at least one image, if the images in the at least one image are generated independently of each other, some unexpected inconsistency, such as inconsistent appearance of the object, exists between different images in the at least one image due to some differences between the generation processes experienced by the different images in the at least one image, which affects the final video generation effect.

Based on the preceding research, to overcome the preceding problem, the present disclosure further provides a possible implementation of the at least one image (the plurality of images shown in FIGS. 2 or 3). In this implementation, the at least one image is generated using a first model (the first model shown in FIG. 2 or the dual UNet-based machine learning model shown in FIG. 3), the first model includes a main network and a reference network, input data of the reference network includes an encoding result of the reference image, and the main network processes an encoding result of the at least one skeleton image based on output data of the reference network; and for any self-attention module (the attention module shown in FIG. 4) in the main network, the main network includes a first network layer (neural network layer 2 shown in FIG. 4) corresponding to the self-attention module, the first network layer generates a discretization feature (features 4, 5, and 6 shown in FIG. 4) corresponding to each of the at least one skeleton image, the reference network includes a second network layer (neural network layer 1 shown in FIG. 4) corresponding to the self-attention module, and the second network layer generates a discretization feature (feature 1, feature 2, or feature 3 shown in FIG. 4) corresponding to the reference image; and for any skeleton image of the at least one skeleton image, the self-attention module performs self-attention processing on a concatenation result (input data of the attention module shown in FIG. 4) of the discretization feature corresponding to the skeleton image, discretization features corresponding to skeleton images other than the skeleton image in the at least one skeleton image, and the discretization feature corresponding to the reference image, to obtain a processed feature (features in the processed feature shown in FIG. 4) corresponding to the skeleton image. In this manner, consistency between generation results obtained by different generation links in the main network may be improved by sharing information between the different generation links in the main network (the information sharing manner as shown in FIG. 4), which is favorable for better overcoming the defect that exists when the images in the at least one image are generated independently of each other, thereby facilitating a better improvement in the generation effect.

It should be noted that in FIG. 4, the "attention module" refers to any self-attention module that exists in the main network of the first model (the dual UNet-based machine learning model shown in FIG. 3); the "neural network layer 2" refers to a neural network layer that exists in the main network, that is adjacent to the "attention module" in location, and that is located before the "attention module", and the "neural network layer 2" may process (for example, perform tokenization on) each feature in input data (the "features in the main network" shown in FIG. 4) of the "neural network layer 2" respectively, to obtain a processing result of each feature (three different features, namely, feature 4, feature 5, and feature 6 shown in FIG. 4); and the "neural network layer 1" refers to a neural network layer that exists in the reference network of the first model and that may provide some features to the "attention module". A location of the "neural network layer 1" in the reference network is the same as a location of the "neural network layer 2" in the main network. The "neural network layer 1" may process (for example, perform tokenization on) each feature in input data (the "features in the reference network" shown in FIG. 4) of the "neural network layer 1" respectively, to obtain a processing result (three same features, namely, feature 1, feature 2, and feature 3 shown in FIG. 4) of each feature, so that subsequently, the reference network concatenates all features in output data of the "neural network layer 1" and sends the concatenated features to the main network, so that the main network may construct input data of the "attention module" by using the features received from the reference network and the output data of the "neural network layer 2".

It should be further noted that for the reference network shown in FIG. 4, because the input data of the reference network includes only the reference image, to better affect the processing process of the main network, when the input data of the main network includes M pieces of data (3 pieces of data shown in FIGS. 3 or 4), M copies of the input data of the reference network may be made, so that the reference network may separately process each piece of data according to M generation links, so that subsequently, an jth generation link in the reference network provides features to an jth generation link in the main network, where j is a positive integer, j≤M, and M is a positive integer, to ensure that the network structure of the reference network is the same as that of the main network, but the functions of the reference network and the main network are different. It may be learned that in FIG. 4, feature 1, feature 2, and feature 3 are the same.

In addition, to better improve a generation effect, the present disclosure further provides a training process of the first model (the model shown in FIG. 3 or the model having the information sharing function shown in FIG. 4). In this manner, the training process of the first model may include the following steps: acquiring at least one label image, a skeleton image of each of the at least one label image, and a reference image corresponding to the at least one label image, wherein an object in the reference image corresponding to the at least one label image and an object in each of the at least one label image are the same; inputting the skeleton image of the at least one label image and the reference image corresponding to the at least one label image into the first model, to obtain a predicted image corresponding to each of the at least one label image that is output by the first model; and updating the first model based on a difference between the predicted image corresponding to the at least one label image and the at least one label image, so that the updated first model has better generation performance, and subsequently, based on the updated first model, the operation may return to the step of "acquiring at least one label image, a skeleton image of each of the at least one label image, and a reference image corresponding to the at least one label image" and subsequent steps, to implement a next round of training process. The operations can be iteratively performed in this manner, until when a first stop condition (for example, a model loss of the first model is less than a first loss threshold, a change rate of the model loss is less than a first change rate threshold, or a number of updates of the first model reaches a first number threshold, etc.) is met, the plurality of rounds of iterative training process for the first model ends.

It should be noted that the label image refers to an image that serves as a ground truth (GT) in the training process of the first model, so as to cause, under the guidance of the label image, an image generated by the first model based on the skeleton image of the label image to be as close to the label image as possible, thereby enabling the first model to better learn how to perform image generation processing under the guidance of the label image. In addition, a number of images in the at least one label image is not limited in the present disclosure, for example, the number of images in the at least one label image is the same as a number of images in the at least one image (or a number of images in the at least one skeleton image).

It should be further noted that the model loss of the first model may represent the generation performance of the first model; and the model loss is determined based on a difference between the predicted image corresponding to the at least one label image and the at least one label image. A calculation manner of the model loss is not limited in the present disclosure, for example, it may be implemented by using any model loss, such as some loss functions used when a diffusion model is trained.

It should be further noted that the acquisition process of the at least one label image and the reference image corresponding to the at least one label image as discussed above is not limited in the present disclosure. For example, when the number of images in the at least one label image is N, the acquisition process may specifically be: after a video is randomly selected from a video library, first randomly selecting N+1 images from the video; and then randomly selecting one image from the N+1 images as the reference image corresponding to the at least one label image, and using images other than the randomly selected image in the N+1 images as the at least one label image. Since the label images and the reference image come from the same video, so that the object in the reference image and the object in each label image are the same object.

It may be learned based on the preceding four paragraphs that for the training process of the first model in a current round, a video may be first randomly selected from a video library; then some images are randomly selected from the video, to randomly select one image from the images as the reference image corresponding to the at least one label image, and use remaining images in the images as the at least one label image, so that after the skeleton image of each of the at least one label image is acquired, the skeleton image of the at least one label image and the reference image are input into the first model, so that the first model may perform image generation processing on the skeleton images by using the reference image as a control condition, to obtain and output the predicted image corresponding to each of the at least one label image, so that the difference between the predicted images and the label images may represent the generation performance presented by the first model in a case of having a control condition, so that the first model may learn how to perform the image generation processing under the control condition through the training process in the current round.

Research has found that to better improve a model training effect, the plurality of rounds of iterative training process for the first model includes not only at least one round of training process performed in a case of having a control condition, but also at least one round of training process performed in a case of having no control condition (unconditional case), to ensure that the finally trained first model has better performance.

It may be learned based on the preceding research that in a possible implementation, when the training process of the first model in the current round belongs to the preceding "training process performed in a case of having a control condition", the training process may satisfy at least the following constraints: the training process is performed or triggered with a first probability (for example, a probability of 0.9), the first model learns to perform image generation processing under a control condition through the training process, and the training process of the first model may include the following steps: acquiring at least one label image, a skeleton image of each of the at least one label image, and a reference image corresponding to the at least one label image, wherein an object in the reference image corresponding to the at least one label image and an object in each of the at least one label image are the same; inputting the skeleton image of the at least one label image and the reference image corresponding to the at least one label image into the first model, to obtain a predicted image corresponding to each of the at least one label image that is output by the first model; and updating the first model based on a difference between the predicted image corresponding to the at least one label image and the at least one label image. In this manner, the image generation performance of the first model in a case of having a control condition may be better optimized by the training process.

It may be learned that for the training process of the first model in the current round, if it is detected that the training process belongs to a training process that is performed or triggered with the first probability and that is performed in a case of having a control condition, a video may be first randomly selected from a video library; then some images are randomly selected from the video, to randomly select one image from the images as the reference image corresponding to the at least one label image, and use remaining images in the images as the at least one label image, so that after the skeleton image of each of the at least one label image is acquired, the skeleton image of the at least one label image and the reference image are input into the first model, so that the first model may perform image generation processing on the skeleton images by using the reference image as a control condition, to obtain and output the predicted image corresponding to each of the at least one label image, so that the difference between the predicted images and the label images may represent the generation performance presented by the first model in the case of having the control condition, so that the first model may learn how to perform the image generation processing under the control condition through the training process in the current round.

It should be noted that an implementation of the first probability is not limited in the present disclosure. For example, the first probability may be set based on a scenario requirement of an actual application scenario. For another example, the first probability may be 0.9.

Research has found that although it is expected that different generation links in the first model may generate different images through training, to better improve the different generation links in the first model to present consistency for some generated content (for example, the appearance of the object), at least one round of training process that is performed in the case of having the control condition and that requires generation of a same image may be added to the plurality of rounds of iterative training process of the first model.

Research has further found that for the "training process that is performed in the case of having the control condition and that requires the generation of the same image" as discussed above, the larger the difference between the image that needs to be generated by the first model in the training process and the reference image used as the control condition, the more conducive it is to improve the consistency between the different generation links in the first model for some generated content (for example, the appearance of the object).

It may be learned based on the preceding two paragraphs that in a possible implementation, when the training process of the first model in the current round belongs to the preceding " training process that is performed under the control condition and that requires the generation of the same image", the training process may satisfy at least the following constraints: the training process is performed or triggered with a second probability (for example, a probability of 0.1), the first model learns to generate the same image under the control condition through the training process, and the training process of the first model may include the following steps: acquiring the at least one label image, the skeleton image of each of the at least one label image, and the reference image corresponding to the at least one label image, where the object in the reference image corresponding to the at least one label image and the object in each of the at least one label image are the same, each of the at least one label image is the same image, and a difference between a state of the object in the same image and a state of the object in the reference image corresponding to the at least one label image meets a preset condition (for example, reaches a maximum); inputting the skeleton image of the at least one label image and the reference image corresponding to the at least one label image into the first model, to obtain the predicted image corresponding to each of the at least one label image that is output by the first model; and updating the first model based on the difference between the predicted image corresponding to the at least one label image and the at least one label image. In this manner, the different generation links in the first model can be better optimized by the training process to present consistency for some generated content (for example, the appearance of the object), thereby facilitating better improvement of the generation performance of the first model.

It should be noted that the preset condition is not limited in the present disclosure. For example, the preset condition may be determined based on an actual application scenario. For another example, the preset condition may indicate that a difference between the state of the object in the reference image corresponding to the at least one label image and a state of the object in each of the at least one label image is sufficiently large. For still another example, when the reference image and the label images all come from the same video, the preset condition may include that a difference between the state of the object in the reference image and a state of the object in each label image is not less than a difference between a state of the object in an image other than the reference image in the video and the state of the object in each label image.

It may be learned based on the preceding two paragraphs that for the training process of the first model in the current round, if it is detected that the training process belongs to a training process that is performed or triggered with the second probability and that is performed in a case of having a control condition and that requires generation of the same image, a video may be first randomly selected from a video library; then two images with a largest difference therebetween are selected from the video, one image is used as the reference image corresponding to the at least one label image, and the other image is separately used as each of the at least one label image, so that subsequently, the first model may be trained based on the reference image and the label images, to optimize the consistency between the different generation links in the first model, thereby facilitating better improvement of the generation performance of the first model.

It should be noted that an implementation of the second probability is not limited in the present disclosure, as long as it is ensured that the second probability is less than the first probability. For example, the second probability may be set based on a scenario requirement of an actual application scenario. For another example, the second probability may be 0.1. It may be learned that when the first probability is 0.9 and the second probability is 0.1, for the training process of the first model in the current round, the training process belongs to the preceding "training process that is performed in a case of having a control condition and that requires the generation of the same image" with a probability of 0.1, and the training process belongs to a training process, that is performed in a case of having a control condition and that requires generation of different images, with a probability of 0.8.

In addition, to better improve the consistency between the different generation links in the first model for some generated content (for example, the appearance of the object), the present disclosure further provides a possible implementation of the training process of the first model. In this implementation, when the training process of the first model in the current round belongs to the preceding "training process that is performed in a case of having a control condition and that requires the generation of the same image", the training process may satisfy at least the following constraints: the training process is performed or triggered with a second probability (for example, a probability of 0.1), the first model learns to generate the same image under the control condition through the training process, and the training process of the first model may include the following steps: acquiring the at least one label image, the skeleton image of each of the at least one label image, and the reference image corresponding to the at least one label image, where the object in the reference image corresponding to the at least one label image and the object in each of the at least one label image are the same, each of the at least one label image is a same image, the object in the reference image corresponding to the at least one label image is from a front view, and the object in the same image is from a back view; inputting the skeleton image of the at least one label image and the reference image corresponding to the at least one label image into the first model, to obtain the predicted image corresponding to each of the at least one label image that is output by the first model; and updating the first model based on the difference between the predicted image corresponding to the at least one label image and the at least one label image. In this manner, the different generation links in the first model can be better optimized by the training process to present consistency for some generation content (for example, the appearance of the object), thereby facilitating better improvement of the generation performance of the first model.

It may be learned that in the present disclosure, by increasing a backside sampling probability (such as the second probability), the first model can be trained to generate a plurality of same images to ensure that there is relatively good consistency between the different generation links in the first model, which is conducive to better improvement of the generation performance of the first model.

Research has found that to better improve the training effect of the first model, unconditional training processing may be performed for the first model with a specific probability (for example, a probability of 0.1).

Research has further found that when the unconditional training processing is performed for the first model, to better prevent the different generation links in the first model from presenting similar generation performance, images with the largest possible differences, such as images describing different objects, may be generated by the different generation links in the first model, respectively.

It may be learned based on the preceding two paragraphs that to better improve the performance of the first model, the present disclosure further provides a possible implementation of the training process of the first model. In this implementation, when the training process of the first model in the current round belongs to the preceding unconditional training process, the training process may satisfy at least the following constraints: the training process is performed or triggered with a third probability (for example, a probability of 0.1), the first model learns to perform image generation processing without a control condition through the training process, and the training process of the first model may include the following steps: acquiring the at least one label image and the skeleton image of each of the at least one label image, where objects in different label images are different; inputting the skeleton image of the at least one label image into the first model, to obtain the predicted image corresponding to each of the at least one label image that is output by the first model, where input data of the reference network in the first model is 0; and updating the first model based on the difference between the predicted image corresponding to the at least one label image and the at least one label image. In this manner, it may be ensured by the training process that different generation links in the first model each have a unique generation performance, thereby facilitating better differentiation of the generation performance of the generation links in the first model, and facilitating better improvement of the performance of the first model in generating different images.

It may be learned based on the preceding two paragraphs that for the training process of the first model in the current round, if it is detected that the training process belongs to a training process that is triggered with the third probability and that is performed in a case of having no control condition, some videos may be first randomly selected from a video library, so that the videos respectively describe different objects; then one image is selected from each video, to obtain the at least one label image, so that the at least one label image includes the image extracted from each video, thereby causing objects described by different images in the at least one label image to be different, so that after the skeleton image of each of the at least one label image is acquired, the skeleton image of the at least one label image is input into the first model, so that the input data of the reference network in the first model is 0, thereby enabling the first model to perform image generation processing on the skeleton images under the control condition, to obtain and output the predicted image corresponding to each of the at least one label image, so that the difference between the predicted images and the label images may represent the generation performance presented by the first model in a case of having no control condition, the generation performance of the first model may be better optimized by the training process.

It should be noted that an implementation of the third probability is not limited in the present disclosure, as long as it is ensured that a sum of the third probability and the first probability does not exceed 1. For example, the third probability may be set based on a scenario requirement of an actual application scenario. For another example, the third probability may be 0.1.

It may be learned based on the preceding three paragraphs that in the present disclosure, the unconditional training is performed for the first model with a probability of 0.1, so that the input data of the reference network in the first model is 0 under the unconditional training, and the first model may learn how to perform generation processing on images selected from different videos under the unconditional training, which is conducive to better differentiation of the generation performances of the different generation links in the first model, thereby facilitating reinforcement of the performance of the first model in generating different images.

Research has found that to better differentiate the generation performances of different generation links in the first model, different control conditions may be separately provided for the different generation links in the first model, to improve the generation performance presented by the first model in a case of having a control condition.

It may be learned based on the preceding research that to better improve the generation performance of the first model, the present disclosure further provides a possible implementation of the training process of the first model. In this implementation, when the training process of the first model in the current round belongs to the preceding training process that is performed in a case of having a control condition and that requires different images to be generated based on different control conditions, the training process may satisfy at least the following constraints: the training process is performed or triggered with a fourth probability (for example, a probability of 0.1), the first model learns to separately generate, under the different control conditions, images describing different objects through the training process, and the training process of the first model may include the following steps: acquiring the at least one label image, the skeleton image of each of the at least one label image, and a reference image matched with each of the at least one label image, where objects in different label images are different, and for any label image, an object in the label image and an object in the reference image matched with the label image are the same object; inputting the skeleton image of the at least one label image and the reference image matched with the at least one label image into the first model, to obtain the predicted image corresponding to each of the at least one label image that is output by the first model; and updating the first model based on the difference between the predicted image corresponding to the at least one label image and the at least one label image. In this manner, the generation performance presented by the first model in a case of having a control condition may be reinforced by separately providing different control conditions for the different generation links in the first model, thereby facilitating better improvement of the training effect of the first model.

It may be learned based on the preceding two paragraphs that for the training process of the first model in the current round, if it is detected that the training process belongs to a training process that is performed or triggered with the fourth probability and that is performed in case of having a control condition and that requires different images to be generated based on different control conditions, N videos may be first randomly selected from the video library, so that the N videos respectively describe different objects; then two images are randomly selected from an ith video, one image is used as an ith label image, and the other image is used as a reference image matched with the ith label image, so that subsequently, image generation processing may be performed by using the reference image matched with the ith label image as a control condition, so as to cause a result of the image generation processing to be as close as possible to the ith label image, where i is a positive integer, i≤N, and N is a positive integer, therefore, after the skeleton image of each of the N label images is acquired, the skeleton images of the N label images and the reference images matched with the N label images are all input into the first model, so that the first model may separately generate and output, by using the reference images as conditions, the predicted image corresponding to each of the label images, subsequently, the generation performance presented by the first model in a case of having a control condition may be determined based on the difference between the predicted images and the label images, so that the performance of the different generation links in the first model may be reinforced by the training process, thereby facilitating better improvement of the generation performance of the first model.

It should be noted that an implementation of the fourth probability is not limited in the present disclosure. For example, the fourth probability may be set based on a scenario requirement of an actual application scenario. For another example, the fourth probability may be 0.1. It may be learned that when the first probability is 0.9 and the fourth probability is 0.1, for the training process of the first model in the current round, the training process belongs to a training process, that is performed in a case of having a control condition and that requires different images to be generated based on different control conditions, with a probability of 0.1, and the training process belongs to a training process, that is performed in a case of having a control condition and that requires a plurality of images (such as a plurality of different images or a plurality of same images) to be generated based on a same control condition, with a probability of 0.8.

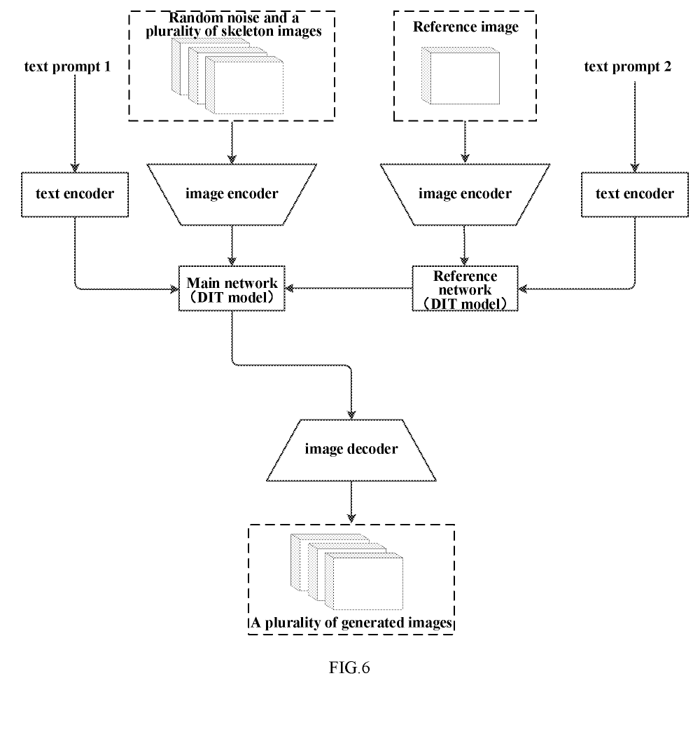

In addition, to better improve the generation performance of the first model, the present disclosure further provides a possible implementation of the preceding training process, that is performed in a case of having a control condition and that requires different images to be generated based on different control conditions. In this implementation, the first model in the training process may satisfy at least the following constraints: input data of the reference network in the first model includes an encoding result of the reference image matched with the at least one label image, and the main network in the first model processes an encoding result of the skeleton image of the at least one label image based on output data of the reference network; and for any self-attention module (the attention module shown in FIG. 5) in the main network, the main network includes a first network layer (neural network layer 2 shown in FIG. 5) corresponding to the self-attention module, the first network layer generates a discretization feature (three different features, namely, feature 4, feature 5, and feature 6 shown in FIG. 5) corresponding to the skeleton image of each of the at least one label image, the reference network includes a second network layer (neural network layer 1 shown in FIG. 5) corresponding to the self-attention module, and the second network layer generates a discretization feature (three different features, namely, feature 7, feature 8, and feature 9 shown in FIG. 5) corresponding to the reference image matched with each of the at least one label image; and for any label image of the at least one label image, the self-attention module performs self-attention processing on a concatenation result (input data of the attention module shown in FIG. 5) of the discretization feature corresponding to the skeleton image of the label image, discretization features corresponding to skeleton images of label images other than the label image in the at least one label image, and the discretization feature corresponding to the reference image matched with the label image, to obtain a processed feature (each in the processed features shown in FIG. 5) corresponding to the skeleton image of the label image. In this manner, by sharing information other than the control condition between the different generation links in the main network (the information sharing manner shown in FIG. 5), the generation effect of such generation links may be optimized, thereby facilitating better improvement in the generation effect.

It should be noted that FIG. 5 differs from FIG. 4 in the following: input data of the reference network shown in FIG. 5 includes a plurality of reference images, so that the reference network may separately provide, for different generation links in the main network shown in FIG. 5, features extracted from the different reference images, so that the different generation links in the main network can perform the generation processing under different control conditions, to better improve the generation performance presented by the first model in a case of having a control condition.

Research has found that because the performance of the DIT is better than that of the UNet network, to better improve the generation performance of the first model, both the main network in the first model and the reference network in the first model may be replaced with DITs of a same structure, so that the replaced first model (the model shown in FIG. 6) has better generation performance. It should be noted that an information sharing manner presented in the main network of the replaced first model is the same as an information sharing manner presented in the main network of the first model before replacement. In addition, implementations of the main network and the reference network of the replaced first model are not limited in the present disclosure. For example, both the main network and the reference network of the replaced first model may be implemented by using N multimodal diffusion transformer blocks (DIT).

It may be learned that the first model including dual DITs (the dual DIT-based machine learning model shown in FIG. 6) is similar to the above first model including dual UNets (the dual UNet-based machine learning model shown in FIG. 3); and the "first model including dual DITs" has at least the following features: a copy of the main network of the "first model including dual DITs" is used as the reference network of the "first model including dual DITs", to ensure that a network structure of the main network of the "first model including dual DITs" is consistent with a network structure of the reference network of the "first model including dual DITs"; and after a certain module in the reference network of the "first model including dual DITs" processes input data of the module to obtain a discretization feature, the discretization feature is concatenated with a discretization feature output by a corresponding parallel module in the main network of the "first model including dual DITs", to obtain a concatenation result, subsequently, a corresponding self-attention module (the attention module shown in FIG. 4) in the main network of the "first model including dual DITs" performs self-attention processing on the concatenation result, to obtain output data (the processed feature shown in FIG. 4) of the self-attention module. It should be noted that a location of the "certain module" in the reference network is the same as a location of the "parallel module" in the main network, the location of the "parallel module" in the main network is adjacent to a location of the "self-attention module" in the main network, and the location of the "parallel module" in the main network is before the location of the "self-attention module" in the main network.

Research has further found that to better improve the performance of the DIT, a text prompt may be provided to the DIT, so that the DIT may learn, from the text prompt, the characteristics of data that needs to be generated by the DIT.

It may be learned based on the preceding research that to better improve the generation performance of the first model, the present disclosure further provides a possible implementation of the training process of the first model. In this implementation, for any round of training process of the first model, the training process may further include: obtaining a first text (text prompt 1 shown in FIG. 6) corresponding to the at least one label image and a second text (text prompt 2 shown in FIG. 6) corresponding to the at least one label image, where the first text and the second text describe the at least one label image, so that the first text and the second text may describe an image expected to be finally generated, thereby causing the input data of the first model to further include the first text and the second text, input data of the reference network in the first model to include at least an encoding result of the second text, and input data of the main network in the first model to include at least an encoding result of the first text, and further causing the first model to know, from the two texts, the characteristics of the image that needs to be generated by the first model, so that it may be ensured that the first model better learns how to perform image generation under the guidance of some text prompts.

It should be noted that the first text may describe data expected to be generated by the main network in the first model, so that the main network may learn, during the training process, how to perform image generation processing under the guidance of the first text; and the implementation of the first text is not limited in the present disclosure. For example, the first text may describe the image (such as the at least one label image as discussed above) expected to be generated by the first model.

It should be further noted that the second text may describe data expected to be generated by the reference network in the first model, so that the reference network may learn, during the training process, how to perform feature extraction processing under the guidance of the second text; and the implementation of the second text is not limited in the present disclosure, as long as it can be ensured that there is no conflict between content described by the second text and the input data (such as the reference image corresponding to the at least one label image as discussed above) of the reference network. It may be learned that in a possible implementation, the second text may indicate a feature (such as clothing or appearance) to be extracted from the input data of the reference network. In addition, because the second text gradually degenerates during the model training process, the second text does not affect the trained first model. Therefore, to improve the training efficiency of the first model, the second text may be determined based on the input data of the reference network, to ensure that the second text may indicate the feature (such as clothing or appearance) to be extracted from the input data of the reference network, so that the second text may better guide the reference network to perform rapid optimization at the beginning of the model training, thereby facilitating an improvement in the training efficiency.

Research has found that because the DIT belongs to a large-scale network, the volume of the first model including dual DITs (the dual DIT-based machine learning model shown in FIG. 6) is relatively large, which results in that when the first model as a whole is trained, a large amount of resources, such as computing resources and time resources, are consumed.

It may be learned based on the preceding research that to better reduce resource overhead of model training, the present disclosure further provides a possible implementation of the training process of the first model. In this implementation, for any round of training process of the first model, the training process may include at least the following steps: adding a module to each self-attention module in the first model; and updating each added module in the first model based on the difference between the predicted image corresponding to the at least one label image and the at least one label image. In this manner, resource overhead of model training may be reduced by using the module additionally added to the first model as a part to be trained, thereby facilitating better improvement of the model training effect.

It may be learned that compared with the training process described above with respect to the first model including dual UNets (the dual UNet-based machine learning model shown in FIG. 3), the training process of the first model including dual DITs (the dual DIT-based machine learning model shown in FIG. 6) has the following differences: the first model including dual DITs adds a small subnetwork to each attention module (such as the preceding self-attention module or the attention module shown in FIG. 4) as a trainable part, and freezes parameters in other parts (such as other networks than the newly added subnetwork in the first model including dual DITs), to ensure that the parameters in the other parts are not trained.

Research has found that for some scenarios, such as a scenario of keeping a background in a reference image during video driving, these scenarios may have the following requirement: given a reference image and a video, driving an object in the reference image to perform a corresponding action in the video while keeping a background in the reference image. For ease of understanding, the following describes an example.

As an example, when the reference image given by the user is obtained by real shooting, the background in the reference image is relatively complex. If the user expects to generate the object in the reference image to perform the corresponding action in the video in the background by means of the given video, an appearance of the object in the reference image, the background in the reference image, and an action sequence in the video are kept when the video is driven based on the reference image.

Research has further found that for the reference image shown in the preceding two paragraphs, when the background in the reference image is relatively complex, it is difficult to generate the complex background, which makes it difficult to keep the complex background in the reference image.

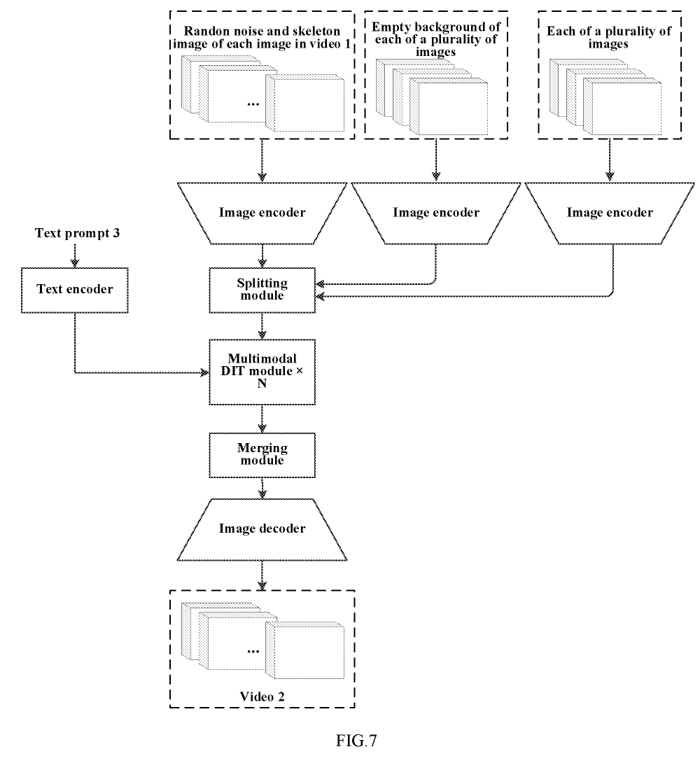

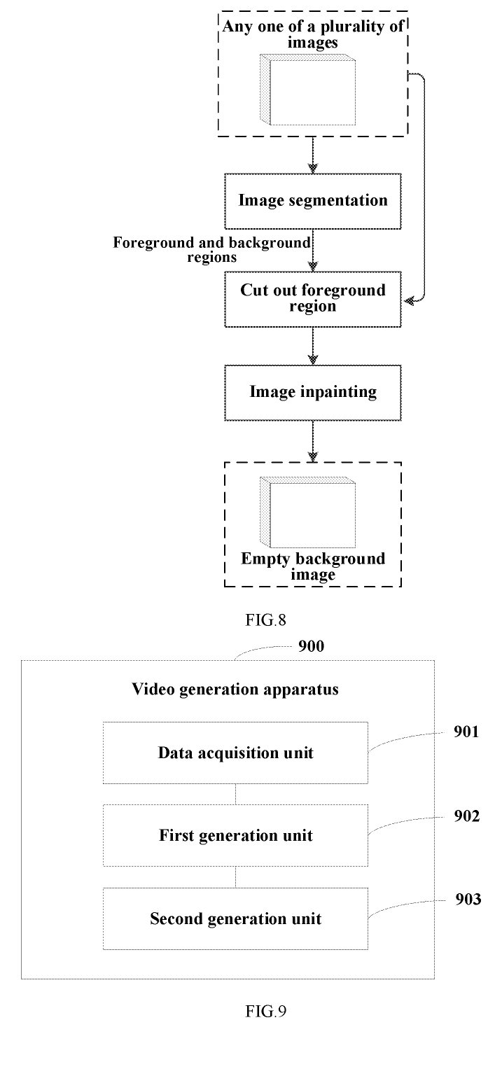

It may be learned based on the research shown in the preceding three paragraphs that to overcome the difficulty shown in the preceding paragraph, the present disclosure further provides a possible implementation of the second video. In this implementation, the second video may be generated further based on an empty background image (the empty background image shown in FIGS. 7 or 8) of each of the at least one image, so that the generation process of the second video is implemented by generating an object in the empty background image, thereby causing only the object to be generated in the generation process of the second video, without needing to generate a background (such as a complex background). This not only overcomes a defect (such as a defect that the quality of video generation is relatively low due to a poor background keeping effect) caused by the difficulty in generating the complex background, but also reduces the amount of generated content to improve generation efficiency, thereby facilitating a better improvement in the generation effect. For any image of the at least one image, an acquisition process of the empty background image of the image includes: identifying a foreground region (the foreground region shown in FIG. 8) from the image, wherein the foreground region indicates a location of an object in the image; cutting out the foreground region from the image; and performing image inpainting on the image to obtain the empty background image of the image, so that the empty background image may better describe background information carried by the image, thereby enabling an image generated by using the empty background image as a base map to better keep the background information, and facilitating a better improvement of the video generation effect.

It may be learned that for some scenarios, such as a scenario of keeping a complex background in the reference image during video driving, after the at least one image (the plurality of images shown in FIG. 7) is obtained by optimizing the reference image given by the user, the empty background image of each of the at least one image is first obtained by processing (the processing shown in FIG. 8) each of the at least one image, so that the empty background image may better represent the background information carried by the at least one image; and then the second video (video 2 shown in FIG. 7) is generated based on the empty background images, the at least one image, and a skeleton image of each image in the first video (video 1 shown in FIG. 7) given by the user, so that in the generation process of the second video, the empty background images may be used as the base maps to draw the object in the reference image to perform the corresponding action in the first video, thereby causing only the object performing the action to be generated and the background (such as the complex background) not to be generated in the generation process of the second video, which facilitates a better improvement in the generation effect.

It should be noted that a manner of identifying the foreground region is not limited in the present disclosure. For example, the foreground region may be identified by using any image segmentation processing, such as the image segmentation processing shown in FIG. 8, or any machine learning model having an image segmentation function. The image segmentation processing may separate a foreground region and a background region from an image. In addition, an implementation of the model is not limited in the present disclosure.

In addition, to better improve the video generation effect, the second video may be generated using the second model (the model shown in FIG. 7). In a possible implementation, the generation process of the second video includes: inputting the at least one image, the empty background image of each of the at least one image, and the skeleton image of each image in the first video into the second model, so that in the second model, after encoding results of the empty background images, an encoding result of each of the at least one image, and encoding results of the skeleton images are concatenated at a channel level, a network other than an image encoder (the image encoder shown in FIG. 7) in the second model processes the concatenated results, to obtain the second video (video 2 shown in FIG. 7). Because the second model performs video generation by generating objects on the empty background images, the second model only needs to generate the object that performs the action, without needing to generate the background (such as the complex background). Therefore, even when the second model does not support generating the complex background, the second model may still complete the video generation task. This facilitates a reduction in the difficulty in obtaining the second model, thereby facilitating a better improvement in the universality of the video generation method provided in the present disclosure.

In addition, to better improve the video generation effect, the present disclosure further provides a possible implementation of the second model. In this implementation, the second model may be trained based on a sample video, a reference image corresponding to the sample video, and an empty background image of the reference image corresponding to the sample video, so that the second model may better learn, from the sample video and corresponding data, how to generate a new video based on an image, an empty background image of the image, and a video.

It should be noted that the training process of the second model is not limited in the present disclosure. For example, the training process may specifically include: acquiring a sample video, a reference image corresponding to the sample video, and an empty background image of the reference image corresponding to the sample video; inputting a skeleton image of each image in the sample video, the reference image, and the empty background image into the second model, to obtain a generated video output by the second model; and updating the second model based on a difference between the generated video and the sample video, so that the updated second model has better video generation performance, and subsequently, based on the updated second model, the operation may return to the step of "acquiring a sample video, a reference image corresponding to the sample video, and an empty background image of the reference image corresponding to the sample video" and subsequent steps, to implement a next round of training process. The operations are iteratively performed in this manner until when a second stop condition (for example, a model loss of the second model is less than a second loss threshold, a change rate of the model loss is less than a second change rate threshold, or a number of updates of the second model reaches a second number threshold) is met, the plurality of rounds of iterative training process for the second model ends. The model loss may indicate the performance of the second model; and the model loss is determined based on the difference between the generated video and the sample video. In addition, a calculation process of the model loss is not limited in the present disclosure.

In addition, an acquisition manner of the "sample video, the reference image corresponding to the sample video, and the empty background image of the reference image corresponding to the sample video" is not limited in the present disclosure. For example, the acquisition manner may specifically include: after a video is randomly selected from a video library and used as a third video, extracting a video clip (such as all or part of the third video) from the third video to obtain the sample video, extracting a first image from the third video to obtain the reference image corresponding to the sample video, and using an empty background image of the first image as the empty background image of the reference image corresponding to the sample video. It should be noted that the first image is not limited in the present disclosure. For example, the first image may be an image randomly selected from the third video, or may be an image that is selected from the third video and that satisfies the restriction that "the posture of the object in the image is simple and the body of the object in the image is complete".

Research has found that in the data acquisition process shown in the preceding paragraph, because the empty background image of the reference image corresponding to the sample video is obtained by processing the reference image, the empty background image carries not only background information in the reference image, but also possibly edge contour information of the object in the reference image. As a result, the second model may learn some wrong knowledges from the edge contour information, and the edge contour information may have some adverse impacts on the training effect of the second model.

It may be learned based on the preceding research that to overcome the adverse impacts shown in the preceding paragraph, the present disclosure further provides an acquisition manner of the "sample video, the reference image corresponding to the sample video, and the empty background image of the reference image corresponding to the sample video". For example, the acquisition manner may specifically include: extracting the video clip and the first image from the third video, and extracting a second image from a fourth video, wherein there is a difference between an empty background image of the second image and the empty background image of the first image; and performing background replacement on each image in the video clip based on the empty background image of the second image to obtain the sample video, so that a background of each image in the sample video is consistent with a background described by the empty background image of the second image, performing background replacement on the first image based on the empty background image of the second image to obtain the reference image corresponding to the sample video, so that a background of the reference image is consistent with the background described by the empty background image of the second image, and using the empty background image of the second image as the empty background image of the reference image corresponding to the sample video. In this manner, information leakage caused by the edge contour of the cut foreground region existing in the empty background image included in original training data may be overcome by replacing a background in the obtained original training data with another background (for example, replacing a background carrying a contour of a skirt with a background carrying a contour of trousers), to ensure that the second model may learn, during the training process, that there is no relationship between the edge contour information carried by the empty background image and the finally generated video, to ensure that the trained second model directly ignores the edge contour information carried by the empty background image when performing video generation, thereby enabling the trained second model to better learn how to generate a new video based on an image, an empty background image of the image, and a video.

It should be noted that the execution timing of the process of acquiring the training data through background replacement shown in the preceding paragraph is not limited in the present disclosure. For example, in some scenarios, the process of acquiring the training data through background replacement needs to be performed in each round of training process of the second model, to improve the training effect of the second model. For another example, in some scenarios, to better improve training efficiency, each round of training process of the second model may perform the process of acquiring the training data through background replacement with a specific probability (for example, a probability of 0.2), and perform the process of acquiring the training data shown in the third paragraph from the bottom with the remaining probability (for example, a probability of 0.8). This may better balance both the training effect and the training efficiency of the second model.

It should be further noted that the fourth video can be a video that is selected from a pre-built video library and that is different from the third video, so that there is at least the following difference between the fourth video and the third video: an appearance (such as a look, clothes, and an action) of an object in the fourth video is different from an appearance of an object in the third video. In addition, the second image can be an image randomly selected from the fourth video.

It should be further noted that the implementation of the preceding "there is a difference between the empty background image of the second image and the empty background image of the first image" is not limited in the present disclosure. For example, the implementation may include: an edge contour of a foreground region indicated by the empty background image of the second image is different from an edge contour of a foreground region indicated by the empty background image of the first image.

It should be further noted that to better improve efficiency, when a background in the above second image is the same as a background of each image in the above third video, the acquisition manner of the "sample video, the reference image corresponding to the sample video, and the empty background image of the reference image corresponding to the sample video" may include: extracting a video clip from the third video to obtain the sample video, extracting a first image from the third video to obtain the reference image corresponding to the sample video, so that an edge contour of the object in the reference image is different from an edge contour of an object in the second image extracted from the fourth video, and using the empty background image of the second image as the empty background image of the reference image corresponding to the sample video. This is conducive to improving the efficiency of acquiring the training data.

In addition, to better improve the restoration effect of the second model for some complex actions (such as a turning action), the present disclosure further provides a possible implementation of the sample video used in a round of training process of the second model. In this implementation, the acquisition process of the sample video includes: extracting a video clip from a third video, wherein an object in a first frame image of the video clip is from a front view, and an object in a last frame image of the video clip is from a back view; and determining the sample video based on the video clip, so that the sample video may describe a complete turning action, thereby enabling training data constructed based on the sample video to better describe the characteristics of the turning action, and enabling the second model to learn from the training data how to better generate the turning action, which is conducive to improving the generation effect of the second model in a turning scenario.

It may be learned that in a possible implementation, for the current round of training process of the second model, after a video is randomly selected from the video library and used as the third video, a front image and a back image are first identified from the third video based on a skeleton image of each image in the third video, so that an object in the front image is from a front view, and an object in the back image is from a back view; then a video clip from the front image to the back image is extracted from the third video and used as the sample video, so that an object in a first frame image of the sample video is from the front view, and an object in a last frame image of the sample video is from the back view, thereby enabling the sample video to describe a complete turning action; and then an image is randomly extracted from the third video and used as the reference image corresponding to the sample video, and an empty background image of the randomly extracted image is used as the empty background image of the reference image corresponding to the sample video, so that the second model may be subsequently trained based on the sample video, the reference image corresponding to the sample video, and the empty background image of the reference image corresponding to the sample video.

It should be noted that the acquisition process of the training data shown in the preceding two paragraphs may occur with a specific probability in the plurality of rounds of iterative training process of the second model. For example, the acquisition process may occur with a probability of 0.2.

In addition, in some scenarios, such as a scenario of keeping a background in the video given by the user during video driving, to better improve the video generation effect, the present disclosure further provides a possible implementation of the second video. In this implementation, the second video may be generated further based on an empty background image of each image in the first video, so that a background change indicated by the second video is consistent with a background change indicated by the empty background image of each image in the first video, thereby enabling the second video to present a state of the object in the reference image under the background change indicated by the first video, and enabling the background in the first video to be better kept during video generation, which is favorable for improving the video generation effect.

It may be learned that in a possible implementation, after the first video (video 1 shown in FIG. 2) given by the user is acquired, a skeleton image and an empty background image of each image in the first video are first acquired, so that the action sequence indicated by the first video may be more accurately described by the skeleton images, and the background change indicated by the first video may be more accurately described by the empty background images; and then the second video is generated based on the skeleton images, the empty background images, and the at least one image (a plurality of images shown in FIG. 2) obtained by optimizing the reference image given by the user, so that the generation process of the second video may be implemented by generating an object on the empty background images, thereby causing only the object to be generated in the generation process of the second video, without needing to generate a background, and then effectively overcoming a defect caused by a complex background in the first video, which is favorable for improving a background keeping effect, to better improve the video generation effect.

It should be noted that the generation manner of the second video shown in the preceding paragraph is not limited in the present disclosure. For example, when the second video is generated using the second model, the generation process of the second video may include: inputting the skeleton image of each image in the first video, the empty background image of each image in the first video, and the at least one image into the second model, so that the second model obtains and outputs the second video in which the second model is located, according to the processing process shown in FIG. 7.

It should be further noted that for any image (such as each image in the first video), the empty background image of the image may describe the background characteristics of the image, so that when image generation is performed based on the empty background image, the image generation may be implemented by adding an object to the empty background image, to effectively reduce the amount of generated content. This may not only improve generation efficiency, but also improve the background keeping effect, thereby facilitating a better improvement of the generation effect. In addition, for the related content of the empty background image, reference can be made to the preceding texts. For brevity, details are not described herein again.

It may be learned based on the related content of the above video generation method that the solution provided in the present disclosure has the following characteristics: the solution may generate, based on the complex and diverse reference image given by the user, a plurality of new images (such as the above plurality of images) that are unchanged in appearance and simple in posture, so that the new images present high consistency with the reference image in terms of texture details; and the solution implements video generation processing in a real scenario by driving the object in the reference image to perform the corresponding actions in the video (such as the preceding first video) given by the user, thereby enabling the solution to better generate a real and natural object driving result in the real scenario in which the complex reference image is acquired, and enabling the solution to present relatively strong stability even in a difficult scenario such as turning around.

Based on the video generation method provided in the embodiments of the present disclosure, an embodiment of the present disclosure further provides a video generation apparatus. The apparatus will be described below with reference to FIG. 9. FIG. 9 is a schematic structural diagram of a video generation apparatus according to an embodiment of the present disclosure. It should be noted that for the technical details of the video generation apparatus provided in the embodiments of the present disclosure, reference can be made to the related content of the above video generation method.

As shown in FIG. 9, a video generation apparatus 900 provided in an embodiment of the present disclosure includes:
a data acquisition unit 901 configured to acquire a reference image, a first video, and at least one skeleton image, wherein different skeleton images indicate different information, and the information includes an action and/or a view;
a first generation unit 902 configured to generate at least one image based on the reference image and the at least one skeleton image, wherein the at least one image indicates a state of an object in the reference image under the information indicated by each of the at least one skeleton image; and
a second generation unit 903 configured to generate a second video based on the at least one image and the first video, wherein the second video indicates states of the object in the reference image under an action sequence indicated by the first video.

In a possible implementation, the first generation unit 902 is further configured to: in response to detecting that the reference image does not satisfy a constraint, generating the at least one image based on the reference image and the at least one skeleton image, wherein each of the at least one image satisfies the constraint, the constraint indicates a requirement for a body posture and/or body integrity of an object in an image used in a video generation process, and the used image indicates an appearance of the object in a video obtained through the video generation process.

In a possible implementation, the at least one image is generated using a first model, the first model comprises a main network and a reference network, input data of the reference network comprises an encoding result of the reference image, and the main network processes an encoding result of the at least one skeleton image based on output data of the reference network; for any self-attention module in the main network, the main network comprises a first network layer corresponding to the self-attention module, the first network layer generates a discretization feature corresponding to each of the at least one skeleton image, the reference network comprises a second network layer corresponding to the self-attention module, and the second network layer generates a discretization feature corresponding to the reference image; and for any skeleton image of the at least one skeleton image, the self-attention module performs self-attention processing on a concatenation result of the discretization feature corresponding to the skeleton image, discretization features corresponding to skeleton images other than the skeleton image in the at least one skeleton image, and the discretization feature corresponding to the reference image, to obtain a processed feature corresponding to the skeleton image.

In a possible implementation, the at least one image is generated using a first model; and a training process of the first model includes: acquiring at least one label image, a skeleton image of each of the at least one label image, and a reference image corresponding to the at least one label image, wherein an object in the reference image corresponding to the at least one label image and an object in each of the at least one label image are the same; inputting the skeleton image of the at least one label image and the reference image corresponding to the at least one label image into the first model, to obtain a predicted image corresponding to each of the at least one label image that is output by the first model; and updating the first model based on a difference between the predicted image corresponding to the at least one label image and the at least one label image

In a possible implementation, the training process is performed or triggered with a first probability, and the first model learns to perform image generation processing under a control condition through the training process.

In a possible implementation, wherein the training process is performed or triggered with a second probability, and the first model learns to generate a same image under a control condition through the training process; and each of the at least one label image is the same image, and a difference between a state of the object in the same image and a state of the object in the reference image corresponding to the at least one label image meets a preset condition.

In a possible implementation, the object in the reference image corresponding to the at least one label image is from a front view, and the object in the same image is at a back view.

In a possible implementation, the training process is performed or triggered with a third probability, and the first model learns to perform image generation processing under no control condition through the training process; and the acquiring at least one label image, a skeleton image of each of the at least one label image, and a reference image corresponding to the at least one label image includes: acquiring the at least one label image and the skeleton image of each of the at least one label image, wherein objects in different label images are different; and the inputting the skeleton image of the at least one label image and the reference image corresponding to the at least one label image into the first model includes: inputting the skeleton image of the at least one label image into the first model, wherein input data of a reference network in the first model is 0.

In a possible implementation, the training process is performed or triggered with a fourth probability, and the first model learns to generate images describing different objects under different control conditions through the training process; and the acquiring at least one label image, a skeleton image of each of the at least one label image, and a reference image corresponding to the at least one label image includes: acquiring the at least one label image, the skeleton image of each of the at least one label image, and a reference image matched with each of the at least one label image, wherein objects in different label images are different, and for any label image, an object in the label image and an object in the reference image matched with the label image are the same; and the inputting the skeleton image of the at least one label image and the reference image corresponding to the at least one label image into the first model comprises: inputting the skeleton image of the at least one label image and the reference image matched with the at least one label image into the first model.

In a possible implementation, input data of a reference network in the first model comprises an encoding result of the reference image matched with the at least one label image, and the main network in the first model processes an encoding result of the skeleton image of the at least one label image based on output data of the reference network; for any self-attention module in the main network, the main network comprises a first network layer corresponding to the self-attention module, the first network layer generates a discretization feature corresponding to the skeleton image of each of the at least one label image, the reference network comprises a second network layer corresponding to the self-attention module, and the second network layer generates a discretization feature corresponding to the reference image matched with each of the at least one label image; and for any label image of the at least one label image, the self-attention module performs self-attention processing on a concatenation result of the discretization feature corresponding to the skeleton image of the label image, discretization features corresponding to skeleton images of label images other than the label image in the at least one label image, and the discretization feature corresponding to the reference image matched with the label image, to obtain a processed feature corresponding to the skeleton image of the label image.

In a possible implementation, the training process further includes: acquiring a first text corresponding to the at least one label image and a second text corresponding to the at least one label image, wherein the first text and the second text describe the at least one label image; and wherein, input data of the first model further includes the first text and the second text, input data of the reference network in the first model comprises at least an encoding result of the second text, and input data of the main network in the first model comprises at least an encoding result of the first text

In a possible implementation, the training process further includes: adding a module to each self-attention module in the first model; and the updating the first model based on a difference between the predicted image corresponding to the at least one label image and the at least one label image includes: updating each added module in the first model based on the difference between the predicted image corresponding to the at least one label image and the at least one label image.

In a possible implementation, the second video is generated further based on an empty background image of each of the at least one image; and for any one of the at least one image, an acquisition process of the empty background image of the image includes: identifying a foreground region from the image, wherein the foreground region indicates a location of an object in the image; cutting out the foreground region from the image; and performing image inpainting on the image to obtain the empty background image of the image.

In a possible implementation, the second video is generated using a second model, and the second model is trained based on a sample video, a reference image corresponding to the sample video, and an empty background image of a reference image corresponding to the sample video; and an acquisition process of the sample video, the reference image corresponding to the sample video, and the empty background image of the reference image corresponding to the sample video, comprises: extracting a video clip from a third video to obtain the sample video, extracting a first image from the third video to obtain the reference image corresponding to the sample video, and using an empty background image of the first image as the empty background image of the reference image corresponding to the sample video; or, an acquisition process of the sample video, the reference image corresponding to the sample video, and the empty background image of the reference image corresponding to the sample video, comprises: extracting the video clip and the first image from the third video, and extracting a second image from a fourth video, wherein there is a difference between an empty background image of the second image and the empty background image of the first image; and performing background replacement on each image in the video clip based on the empty background image of the second image to obtain the sample video, performing background replacement on the first image based on the empty background image of the second image to obtain the reference image corresponding to the sample video, and using the empty background image of the second image as the empty background image of the reference image corresponding to the sample video.

In a possible implementation, the second video is generated using a second model, and the second model is trained based on a sample video; and an acquisition process of the sample video includes: extracting a video clip from a third video, where an object in a first frame image of the video clip is from a front view, and an object in a last frame image of the video clip is from a back view; and determining the sample video based on the video clip.

In a possible implementation, the at least one skeleton image includes a skeleton image of an image selected from the first video; and/or the second video is generated based on a skeleton image of each image in the first video.

It may be learned based on the related content of the preceding video generation apparatus 900 that the working principle of the apparatus 900 includes: a reference image (such as an image that is given by a user and that may indicate an appearance of an object in a final generated image), a first video (a video that is given by a user and that indicates an action sequence), and at least one skeleton image (such as a skeleton image that describes a certain action) are obtained first, where different skeleton images indicate different information (such as an action and/or a view); then at least one image (such as some images that may present simple actions and are complete in frame) is generated based on the reference image and the at least one skeleton image, so that the at least one image may indicate a state of the object in the reference image under the information indicated by each of the at least one skeleton image, thereby enabling the at least one image to better present characteristics of the object; and then a second video is generated based on the at least one image and the first video, so that the second video may indicate states of the object in the reference image under the action sequence indicated by the first video, thereby driving the object in the reference image to act according to the action sequence indicated by the video. Because the at least one skeleton image may indicate some simple actions, the at least one image generated based on the at least one skeleton image and the reference image may more accurately and comprehensively describe the characteristics of the object in the reference image, so that the video generated based on the at least one image may better maintain the characteristics of the object, which is favorable for improving a video generation effect.

In addition, an embodiment of the present disclosure further provides an electronic device. The device includes a processor and a memory, where the memory is configured to store an instruction or a computer program, and the processor is configured to execute the instruction or the computer program in the memory, to enable the electronic device to perform any implementation of the video generation method provided in the embodiments of the present disclosure.

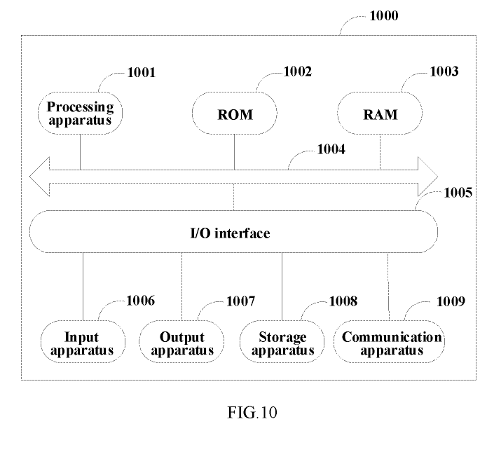

Referring to FIG. 10, FIG. 10 is a schematic diagram of a structure of an electronic device 1000 suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (for example, a vehicle navigation terminal), and fixed terminals such as a digital TV and a desktop computer. The electronic device shown in FIG. 10 is merely an example, and shall not impose any limitation on the function and scope of use of the embodiments of the present disclosure.

As shown in FIG. 10, the electronic device 1000 may include a processing apparatus (such as a central processing unit and a graphics processing unit) 1001, which may perform various appropriate actions and processing based on a program stored in a read-only memory (ROM) 1002 or a program loaded into a random-access memory (RAM) 1003 from a storage apparatus 1008. The RAM 1003 further stores various programs and data required for operations of the electronic device 1000. The processing apparatus 1001, the ROM 1002, and the RAM 1003 are interconnected by using a bus 1004. An input/output (I/O) interface 1005 is also connected to the bus 1004.

Usually, the following apparatuses may be connected to the I/O interface 1005: an input apparatus 1006, for example, including a touchscreen, a touchpad, a keyboard, a mouse, a camera, a microphone, an accelerometer, or a gyroscope; an output apparatus 1007, for example, including a liquid crystal display (LCD), a speaker, or a vibrator; a storage apparatus 1008, for example, including a magnetic tape or a hard disk; and a communication apparatus 1009. The communication apparatus 1009 may allow the electronic device 1000 to perform wireless or wired communication with another device to exchange data. Although FIG. 10 shows the electronic device 1000 having various apparatuses, it should be understood that it is not required to implement or have all the shown apparatuses. Alternatively, more or fewer apparatuses may be implemented or provided.

In particular, according to the embodiments of the present disclosure, the process described above with reference to the flowchart may be implemented as a computer software program. For example, an embodiment of the present disclosure includes a computer program product including a computer program carried on a non-transitory computer-readable medium, where the computer program includes program codes for performing the video generation method provided in the present disclosure, for example, the method shown in the flowchart. In such an embodiment, the computer program may be downloaded from a network and installed through the communication apparatus 1009, or may be installed from the storage apparatus 1008, or may be installed from the ROM 1002. When the computer program is executed by the processing apparatus 1001, the preceding functions limited in the method of the embodiments of the present disclosure are performed.

The electronic device provided in this embodiment of the present disclosure belongs to the same inventive concept as the method provided in the preceding embodiments. For technical details not described in detail in this embodiment, reference may be made to the preceding embodiments. This embodiment has the same beneficial effects as the preceding embodiments.

An embodiment of the present disclosure further provides a computer-readable medium having an instruction or a computer program stored thereon, where the instruction or the computer program, when executed by a device, enables the device to perform any implementation of the video generation method provided in the embodiments of the present disclosure.

It should be noted that the preceding computer-readable medium in the present disclosure may be a computer-readable signal medium, a computer-readable storage medium, or any combination thereof. The computer-readable storage medium may be, for example, but is not limited to, an electronic, magnetic, optical, electromagnetic, infrared, or semiconductor system, apparatus, or device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that includes or stores a program, and the program may be used by or used in combination with an instruction execution system, apparatus, or device. In the present disclosure, the computer-readable signal medium may include a data signal propagated on a baseband or as a part of a carrier, and computer-readable program code is carried in the data signal. The data signal propagated in this manner may be in a plurality of forms, and includes, but is not limited to, an electromagnetic signal, an optical signal, or any suitable combination thereof. The computer-readable signal medium may alternatively be any computer-readable medium other than the computer-readable storage medium, and the computer-readable signal medium may send, propagate, or transmit a program used by or in combination with an instruction execution system, apparatus, or device. The program code included in the computer-readable medium may be transmitted in any suitable medium, including but not limited to a wire, an optical cable, a radio frequency (RF), or any suitable combination thereof.

In some implementations, a client and a server may communicate using any currently known or future developed network protocol, such as the hypertext transfer protocol (HTTP), and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The computer-readable medium may be included in the electronic device, or may exist alone without being assembled into the electronic device.

The computer-readable medium carries one or more programs, and the one or more programs, when executed by the electronic device, enable the electronic device to perform the preceding method.

The computer program code for performing the operations of the present disclosure may be written in one or more programming languages or a combination thereof, where the programming languages include, but are not limited to, an object-oriented programming language, such as Java, Smalltalk, and C++, and further include conventional procedural programming languages, such as "C" language or similar programming languages. The program code may be completely executed on a computer of a user, partially executed on a computer of a user, executed as an independent software package, partially executed on a computer of a user and partially executed on a remote computer, or completely executed on a remote computer or server. In the case involving the remote computer, the remote computer may be connected to the computer of the user through any type of network, including a local area network (LAN) or a wide area network (WAN), or may be connected to an external computer (for example, connected through the Internet using an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented in a software manner, and may also be implemented in a hardware manner. The name of a unit/module does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more lines, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

It should be noted that the embodiments in this specification are described in a progressive manner. Each embodiment focuses on a difference from another embodiment, and the same or similar parts between the embodiments may be referred to each other. For a system or apparatus disclosed in an embodiment, because the system or apparatus corresponds to the method disclosed in the embodiment, the description is relatively simple. For related parts, refer to the description of the method.

It should be understood that in the present disclosure, "at least one (item)" means one or more, and "a plurality of" means two or more. The term "and/or" describes an association relationship between associated objects, and represents that three relationships may exist. For example, "A and/or B" may represent the following three cases: Only A exists, only B exists, and both A and B exist, where A and B may be singular or plural. The character "/" generally indicates an "or" relationship between the associated objects. At least one of the following items (pieces) or a similar expression thereof indicates any combination of these items, including a single item (piece) or any combination of a plurality of items (pieces). For example, at least one of a, b, or c may represent: a, b, c, "a and b", "a and c", "b and c", or "a, b, and c", where a, b, and c may be singular or plural.

It should be further noted that in this specification, relational terms such as first and second are used only to distinguish one entity or operation from another entity or operation, and do not necessarily require or imply any actual relationship or order between these entities or operations. Moreover, the terms "include", "include", or any other variant thereof are intended to cover non-exclusive inclusion, so that a process, method, object, or device that includes a list of elements includes not only those elements, but also other elements not expressly listed or elements inherent to such a process, method, object, or device. Without further restrictions, an element defined by the phrase "includes a" does not exclude the existence of another identical element in the process, method, object, or device that includes the element.

The steps of the method or algorithm described in conjunction with the embodiments disclosed herein may be directly implemented by using hardware, a software module executed by a processor, or a combination thereof. The software module may be placed in a random-access memory (RAM), a memory, a read-only memory (ROM), an electrically programmable ROM, an electrically erasable programmable ROM, a register, a hard disk, a removable magnetic disk, a CD-ROM, or a storage medium of any other form known in the art.

The preceding descriptions of the disclosed embodiments enable those skilled in the art to implement or use the present disclosure. Various modifications to these embodiments are obvious to those skilled in the art, and the generic principles defined herein may be implemented in other embodiments without departing from the spirit or scope of the present disclosure. Therefore, the present disclosure is not limited to the embodiments shown herein, but is to be accorded the widest scope consistent with the principles and novel features disclosed herein.

1. A video generation method, comprising:
acquiring a reference image, a first video, and at least one skeleton image, wherein different skeleton images indicate different information, and the information comprises at least one of an action or a view;
generating at least one image based on the reference image and the at least one skeleton image, wherein the at least one image indicates a state of an object in the reference image under the information indicated by each of the at least one skeleton image; and
generating a second video based on the at least one image and the first video, wherein the second video indicates states of the object in the reference image under an action sequence indicated by the first video.

2. The method of claim 1, wherein the generating at least one image based on the reference image and the at least one skeleton image comprises:
in response to detecting that the reference image does not satisfy a constraint, generating the at least one image based on the reference image and the at least one skeleton image, wherein each of the at least one image satisfies the constraint, the constraint indicates a requirement for at least one of a body posture or body integrity of an object in an image used in a video generation process, and the used image indicates an appearance of the object in a video obtained through the video generation process.

3. The method of claim 1, wherein the at least one image is generated using a first model, the first model comprises a main network and a reference network, input data of the reference network comprises an encoding result of the reference image, and the main network processes an encoding result of the at least one skeleton image based on output data of the reference network;
for any self-attention module in the main network, the main network comprises a first network layer corresponding to the self-attention module, the first network layer generates a discretization feature corresponding to each of the at least one skeleton image, the reference network comprises a second network layer corresponding to the self-attention module, and the second network layer generates a discretization feature corresponding to the reference image; and
for any skeleton image of the at least one skeleton image, the self-attention module performs self-attention processing on a concatenation result of the discretization feature corresponding to the skeleton image, discretization features corresponding to skeleton images other than the skeleton image in the at least one skeleton image, and the discretization feature corresponding to the reference image, to obtain a processed feature corresponding to the skeleton image.

4. The method of claim 1, wherein the at least one image is generated using a first model; and
a training process of the first model comprises:
acquiring at least one label image, a skeleton image of each of the at least one label image, and a reference image corresponding to the at least one label image, wherein an object in the reference image corresponding to the at least one label image and an object in each of the at least one label image are the same;
inputting the skeleton image of the at least one label image and the reference image corresponding to the at least one label image into the first model, to obtain a predicted image corresponding to each of the at least one label image that is output by the first model; and
updating the first model based on a difference between the predicted image corresponding to the at least one label image and the at least one label image.

5. The method of claim 4, wherein the training process is performed with at least one of a first probability, a second probability, a third probability, or a fourth probability,
wherein, in response to the training process being performed with the first probability, the first model learns to perform image generation processing under a control condition through the training process, or
wherein, in response to the training process being performed with the second probability, the first model learns to generate a same image under a control condition through the training process; and each of the at least one label image is the same image, and a difference between a state of the object in the same image and a state of the object in the reference image corresponding to the at least one label image meets a condition, or
wherein in response to the training process being performed with a third probability, the first model learns to perform image generation processing without a control condition through the training process; and the acquiring at least one label image, a skeleton image of each of the at least one label image, and a reference image corresponding to the at least one label image comprises:
acquiring the at least one label image and the skeleton image of each of the at least one label image, wherein objects in different label images are different; and
the inputting the skeleton image of the at least one label image and the reference image corresponding to the at least one label image into the first model comprises:
inputting the skeleton image of the at least one label image into the first model, wherein input data of a reference network in the first model is 0, or
wherein, in response to the training process being performed with a fourth probability, the first model learns to generate images describing different objects under different control conditions through the training process; and the acquiring at least one label image, a skeleton image of each of the at least one label image, and a reference image corresponding to the at least one label image comprises:
acquiring the at least one label image, the skeleton image of each of the at least one label image, and a reference image matched with each of the at least one label image, wherein objects in different label images are different, and for any label image, an object in the label image and an object in the reference image matched with the label image are the same; and
the inputting the skeleton image of the at least one label image and the reference image corresponding to the at least one label image into the first model comprises:
inputting the skeleton image of the at least one label image and the reference image matched with the at least one label image into the first model.

6. The method of claim 5, wherein, in response to the training process being performed with the second probability, the object in the reference image corresponding to the at least one label image is from a front view, and the object in the same image is from a back view.

7. The method of claim 5, wherein, in response to the training process being performed with a fourth probability, input data of a reference network in the first model comprises an encoding result of the reference image matched with the at least one label image, and the main network in the first model processes an encoding result of the skeleton image of the at least one label image based on output data of the reference network;
for any self-attention module in the main network, the main network comprises a first network layer corresponding to the self-attention module, the first network layer generates a discretization feature corresponding to the skeleton image of each of the at least one label image, the reference network comprises a second network layer corresponding to the self-attention module, and the second network layer generates a discretization feature corresponding to the reference image matched with each of the at least one label image; and
for any label image of the at least one label image, the self-attention module performs self-attention processing on a concatenation result of the discretization feature corresponding to the skeleton image of the label image, discretization features corresponding to skeleton images of label images other than the label image in the at least one label image, and the discretization feature corresponding to the reference image matched with the label image, to obtain a processed feature corresponding to the skeleton image of the label image.

8. The method of claim 4, wherein the training process further comprises:
acquiring a first text corresponding to the at least one label image and a second text corresponding to the at least one label image, wherein the first text and the second text describe the at least one label image; and
wherein, input data of the first model further comprises the first text and the second text, input data of the reference network in the first model comprises at least an encoding result of the second text, and input data of the main network in the first model comprises at least an encoding result of the first text.

9. The method of claim 8, wherein the training process further comprises:
adding a module to each self-attention module in the first model; and
the updating the first model based on a difference between the predicted image corresponding to the at least one label image and the at least one label image comprises:
updating each added module in the first model based on the difference between the predicted image corresponding to the at least one label image and the at least one label image.

10. The method of claim 1, wherein the second video is generated further based on an empty background image of each of the at least one image; and
for any one of the at least one image, an acquisition process of the empty background image of the image comprises:
identifying a foreground region from the image, wherein the foreground region indicates a location of an object in the image;
cutting out the foreground region from the image; and
performing image inpainting on the image to obtain the empty background image of the image.

11. The method of claim 10, wherein the second video is generated using a second model, and the second model is trained based on a sample video, a reference image corresponding to the sample video, and an empty background image of a reference image corresponding to the sample video; and
an acquisition process of the sample video, the reference image corresponding to the sample video, and the empty background image of the reference image corresponding to the sample video, comprises:
extracting a video clip from a third video to obtain the sample video, extracting a first image from the third video to obtain the reference image corresponding to the sample video, and using an empty background image of the first image as the empty background image of the reference image corresponding to the sample video;
or
an acquisition process of the sample video, the reference image corresponding to the sample video, and the empty background image of the reference image corresponding to the sample video, comprises:
extracting the video clip and the first image from the third video, and extracting a second image from a fourth video, wherein there is a difference between an empty background image of the second image and the empty background image of the first image; and
performing background replacement on each image in the video clip based on the empty background image of the second image to obtain the sample video, performing background replacement on the first image based on the empty background image of the second image to obtain the reference image corresponding to the sample video, and using the empty background image of the second image as the empty background image of the reference image corresponding to the sample video.

12. The method of claim 10, wherein the second video is generated using a second model, and the second model is trained based on a sample video; and
an acquisition process of the sample video comprises extracting a video clip from a third video, wherein an object in a first frame image of the video clip is from a front view, and an object in a last frame image of the video clip is from a back view; and determining the sample video based on the video clip.

13. The method of claim 1, wherein the at least one skeleton image comprises a skeleton image of an image selected from the first video; or
the second video is generated based on a skeleton image of each image in the first video.

14. An electronic device, comprising: a processor and a memory, wherein
the memory is configured to store instructions or a computer program; and
the processor is configured to execute the instructions or the computer program in the memory, to enable the electronic device to perform:
acquiring a reference image, a first video, and at least one skeleton image, wherein different skeleton images indicate different information, and the information comprises at least one of an action or a view;
generating at least one image based on the reference image and the at least one skeleton image, wherein the at least one image indicates a state of an object in the reference image under the information indicated by each of the at least one skeleton image; and
generating a second video based on the at least one image and the first video, wherein the second video indicates states of the object in the reference image under an action sequence indicated by the first video.

15. The electronic device of claim 14, wherein the generating at least one image based on the reference image and the at least one skeleton image comprises:
in response to detecting that the reference image does not satisfy a constraint, generating the at least one image based on the reference image and the at least one skeleton image, wherein each of the at least one image satisfies the constraint, the constraint indicates a requirement for at least one of a body posture or body integrity of an object in an image used in a video generation process, and the used image indicates an appearance of the object in a video obtained through the video generation process.

16. The electronic device of claim 14, wherein the at least one image is generated using a first model, the first model comprises a main network and a reference network, input data of the reference network comprises an encoding result of the reference image, and the main network processes an encoding result of the at least one skeleton image based on output data of the reference network;
for any self-attention module in the main network, the main network comprises a first network layer corresponding to the self-attention module, the first network layer generates a discretization feature corresponding to each of the at least one skeleton image, the reference network comprises a second network layer corresponding to the self-attention module, and the second network layer generates a discretization feature corresponding to the reference image; and
for any skeleton image of the at least one skeleton image, the self-attention module performs self-attention processing on a concatenation result of the discretization feature corresponding to the skeleton image, discretization features corresponding to skeleton images other than the skeleton image in the at least one skeleton image, and the discretization feature corresponding to the reference image, to obtain a processed feature corresponding to the skeleton image.

17. The electronic device of claim 14, wherein the at least one image is generated using a first model; and
a training process of the first model comprises:
acquiring at least one label image, a skeleton image of each of the at least one label image, and a reference image corresponding to the at least one label image, wherein an object in the reference image corresponding to the at least one label image and an object in each of the at least one label image are the same;
inputting the skeleton image of the at least one label image and the reference image corresponding to the at least one label image into the first model, to obtain a predicted image corresponding to each of the at least one label image that is output by the first model; and
updating the first model based on a difference between the predicted image corresponding to the at least one label image and the at least one label image.

18. A non-transitory computer-readable storage medium having instructions or a computer program stored thereon, wherein the instructions or the computer program, when executed by a device, enables the device to perform :
acquiring a reference image, a first video, and at least one skeleton image, wherein different skeleton images indicate different information, and the information comprises at least one of an action or a view;
generating at least one image based on the reference image and the at least one skeleton image, wherein the at least one image indicates a state of an object in the reference image under the information indicated by each of the at least one skeleton image; and
generating a second video based on the at least one image and the first video, wherein the second video indicates states of the object in the reference image under an action sequence indicated by the first video.

19. The non-transitory computer-readable storage medium of claim 18, wherein the generating at least one image based on the reference image and the at least one skeleton image comprises:
in response to detecting that the reference image does not satisfy a constraint, generating the at least one image based on the reference image and the at least one skeleton image, wherein each of the at least one image satisfies the constraint, the constraint indicates a requirement for at least one of a body posture or body integrity of an object in an image used in a video generation process, and the used image indicates an appearance of the object in a video obtained through the video generation process.

20. The non-transitory computer-readable storage medium of claim 18, wherein the at least one image is generated using a first model, the first model comprises a main network and a reference network, input data of the reference network comprises an encoding result of the reference image, and the main network processes an encoding result of the at least one skeleton image based on output data of the reference network;
for any self-attention module in the main network, the main network comprises a first network layer corresponding to the self-attention module, the first network layer generates a discretization feature corresponding to each of the at least one skeleton image, the reference network comprises a second network layer corresponding to the self-attention module, and the second network layer generates a discretization feature corresponding to the reference image; and
for any skeleton image of the at least one skeleton image, the self-attention module performs self-attention processing on a concatenation result of the discretization feature corresponding to the skeleton image, discretization features corresponding to skeleton images other than the skeleton image in the at least one skeleton
image, and the discretization feature corresponding to the reference image, to obtain a processed feature corresponding to the skeleton image.
